(19) United States
(12) Patent Application Publication
(10) Pub. No.: US 2026/0318489 A1
(43) Pub. Date: Oct. 15, 2026

(54) EMISSIONS MANAGEMENT MODULES AND ASSOCIATED SYSTEMS AND METHODS

(71) Applicant: Archrock Services, L.P., Houston, TX (US)

(72) Inventors: Benjamin Castagnos, Youngsville, LA (US); Tyler Davis, Cypress, TX (US); Benjamin Galassini, Thornton, CO (US); John H. Johnson, Fulshear, TX (US); Evan Elie Judice, Katy, TX (US); Michael Wasson, Katy, TX (US); Walter E. Williams, Houston, TX (US)

(73) Assignee: Archrock Services, L.P., Houston, TX (US)

(21) Appl. No.: 19/717,373

(22) Filed: Jun. 23, 2026

Related U.S. Application Data
(63) Continuation-in-part of application No. 18/973,709, filed on Dec. 9, 2024, now Pat. No. 12,698,868.
Application No. 18/973,709 is a continuation of application No. 17/976,000, filed on Oct. 28, 2022, now Pat. No. 12,169,047.
(60) Provisional application No. 63/273,703, filed on Oct. 29, 2021.

(51) Int. Cl. F17D 5/02; F17D 1/07; F17D 5/00

(52) U.S. Cl. CPC F17D 5/02; F17D 1/07; F17D 5/005

(57) ABSTRACT

A natural gas system includes a process suction conduit, a compressor package to receive natural gas from the process suction conduit and to increase a pressure of the flow of natural gas whereby it is discharged from the compressor package as a pressurized flow of natural gas, a process discharge conduit connected downstream of the compressor package, and an emissions management module (EMM) coupled to the compressor package and configured to capture emissions from the compressor package, wherein the EMM includes a vapor recovery unit (VRU) configured to periodically circulate the captured emissions from the VRU along an emissions discharge conduit coupled to the VRU such that the captured emissions are discharged directly to at least one of the process suction conduit, a fuel gas system of the natural gas system, and a hydrocarbon processing component of the natural gas system that is separate from the compressor package.

### CROSS-REFERENCE TO RELATED APPLICATIONS

This application is a continuation-in-part of U.S. patent application Ser. No. 18/973,709, filed Dec. 9 2024, entitled “Emissions Management Modules and Associated Systems and Methods,” which is a continuation of U.S. nonprovisional patent application Ser. No. 17/976,000, filed Oct. 28, 2022, entitled “Emissions Management Modules and Associated Systems and Methods,” which claims benefit of U.S. provisional patent application Ser. No. 63/273,703 filed Oct. 29, 2021, and entitled “Emissions Management Modules and Associated Systems and Methods,” all of which are hereby incorporated herein by reference in their entirety for all purposes.

### BACKGROUND

Natural gas is a naturally occurring hydrocarbon gas utilized for a variety of purposes, including as an energy source for heating, cooking, and for the generation of electricity. Natural gas may also comprise a fuel source for chemical and refining processes in the petrochemical and other industries. Natural gas systems include natural gas wells from which the natural gas is produced as well as pipeline systems through which the natural gas is transported to gathering systems, processing systems, etc., and ultimately to end users for consumption. Methane (CH₄), the primary component of natural gas is a greenhouse gas thought to have a potentially harmful impact on the Earth's atmosphere when released to the environment. Emissions of hydrocarbons, both accidental and by design, from the natural gas system are one of many potential sources of methane released to the environment. One potential source of leakage and/or venting of these materials from the natural gas system are natural gas compressor packages that form part of the natural gas system. Compressor packages are used, among other things, to transport natural gas to and through natural gas pipelines. Typical compressor packages of natural gas systems include a “driver” (typically a reciprocating internal combustion engine powered by natural gas) that drives a reciprocating natural gas compressor.

U.S. Pat. Publ. No. 2006/0042719 Al discloses a gas recovery system designed to recover vent gas emanating from a gas processing system and return the gas to the processing system. The gas recovery system includes a pressurized motive gas that is directed through a vacuum generating apparatus that mixes the vent gas with a motive gas to create a mixed gas stream. The mixed gas stream is transported away from the vacuum generating apparatus by a mixed gas outlet line. A pressure regulation system continuously monitors and adjusts the pressure of the vent gas supply inlet to a jet compressor above a predetermined pressure.

U.S. Pat. Publ. No. 2008/0251129 Al discloses a system and a method for recovering and increasing the pressure of seal leak gas for recycle or passage to further processing.

U.S. Pat. Publ. No. 2017/0122320 Al discloses a device for compressing and expanding gases, wherein the device comprises an apparatus that can be driven in two directions, whereby in one direction the apparatus operates to compress a gas and in the other direction the apparatus operates to expand a gas.

U.S. Pat. Publ. No. 2018/0100385 Al discloses a gas emissions recovery system designed to receive fugitive gas emissions from a compressor and pressurize those emissions using a controlled double acting liquid piston compressor system having dual fluid chambers capable of compressing light hydrocarbons that escape from a compressor to higher pressures using a piston motion.

There is a need for improved apparatuses, systems, and/or methods for capturing emissions. Such improvements would reduce greenhouse gas emissions by providing improved energy efficiency and/or reliability versus currently available emissions collection systems. Ideally, such improved apparatuses, systems, and/or methods would be highly flexible and could be implemented with commonly used equipment and familiar techniques.

### SUMMARY

In general, the present disclosure relates to mitigation of methane emissions to the atmosphere by capturing fugitive methane emissions including but not limited to the blowdown, the pneumatic control gas system, and/or the compressor rod packings of natural gas compressor package.

In some embodiments, a natural gas system is disclosed herein. The natural gas system comprises a process suction conduit, a compressor package connected downstream of the process suction conduit, a process discharge conduit connected downstream of the compressor package, and an emissions management module (EMM) coupled to the compressor package. The compressor package is configured to receive a flow of natural gas from the process suction conduit and to increase a pressure of the flow of natural gas whereby the flow of natural gas is discharged from the compressor package as a pressurized flow of natural gas. The process discharge conduit is configured to receive the flow of natural gas discharged from the compressor package. The EMM is configured to capture emissions from the compressor package, wherein the EMM comprises a vapor recovery unit (VRU) configured to periodically circulate the captured emissions from the VRU to an emissions discharge conduit.

In some embodiments of the natural gas system, the EMM further comprises an emissions inlet conduit and a VRU control system, and the VRU comprises a circulator. The periodic circulation of the captured emissions from the VRU to the emissions discharge conduit is enabled by the VRU control system. The VRU control system activates the circulator to withdraw the captured emissions from the emissions inlet conduit when a pressure in the inlet conduit reaches an upper threshold value. The VRU control system maintains circulation of the withdrawn captured emissions from the emissions inlet conduit to the emissions discharge conduit, thereby reducing the pressure in the emissions inlet conduit. The VRU control system deactivates the circulator to terminate withdrawal of the captured emissions from the emissions inlet conduit when the pressure in the emissions inlet conduit reaches a lower threshold value.

In some embodiments of the natural gas system, the VRU control system deactivates the circulator if the pressure in the emissions inlet conduit does not reach the lower threshold within a preselected time period.

In some embodiments of the natural gas system, the emissions inlet conduit fluidly connects the VRU to an emissions source having an initial pressure greater the upper threshold value. In some embodiments, the ratio of the upper threshold value of pressure in the emissions inlet conduit to the pressure in the emissions discharge conduit is in a range of from 1 to 2. The captured emissions flow from the emissions source to the emissions discharge conduit based on differential pressure until the pressure in the emissions inlet conduit reaches the upper threshold value.

In some embodiments of the natural gas system, the emissions inlet conduit fluidly connects the VRU to an emissions source having an initial pressure less than the upper threshold value. In some embodiments, the upper threshold value is in a range of from twice the lower threshold value to less than the pressure in the emissions discharge conduit. The captured emissions accumulate in the emissions inlet conduit until the pressure in the emissions inlet conduit reaches the upper threshold value.

In some embodiments, an emissions management module (EMM) for a natural gas system is disclosed herein. In some embodiments, the EMM comprises a support structure, a high pressure emissions inlet conduit supported on the support structure, a low pressure emissions inlet conduit supported on the support structure, a vapor recovery unit (VRU) supported on the support structure and connected to both the high pressure emissions inlet conduit and the low pressure emissions inlet conduit, and a high pressure emissions discharge conduit and/or a low pressure emissions discharge conduit supported on the support structure connected to the VRU. The high pressure emissions inlet conduit is configured to receive a high pressure stream of emissions from the natural gas system. The low pressure emissions inlet conduit supported on the support structure and configured to receive a low pressure stream of emissions from the natural gas system. A high-pressure emissions discharge conduit and a low-pressure emissions discharge conduit are connected to the VRU, wherein the VRU is configured to periodically circulate the high-pressure stream of emissions and/or the low-pressure stream of emissions from the VRU to a component of the natural gas system.

In some embodiments, a method for capturing emissions from a compressor package of a natural gas system is disclosed herein. In some embodiments, the method comprises transporting a flow of natural gas from a process suction conduit of the natural gas system to a compressor package of the natural gas system. The method further comprises increasing a pressure of the flow of natural gas received from the process suction conduit by the compressor package and discharging the flow of natural gas from the compressor package to a process discharge conduit of the natural gas system. Emissions are captured from the compressor package in an emissions inlet conduit of an EMM of a natural gas system. The captured emissions are then periodically circulated by a VRU of the EMM to the process suction conduit, a fuel gas system of the natural gas system, a hydrocarbon processing component that is separate from the compressor package, or a combination thereof.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or designing other apparatuses and/or processes for carrying out the same purposes of the present invention. It should also be realized by those skilled in the art that such equivalent compositions and/or processes do not depart from the spirit and scope of the invention as set forth in the appended claims. The novel features which are believed to be characteristic of the invention, both as to its configuration and/or method of operation, together with further objects and advantages will be better understood from the following description.

### BRIEF DESCRIPTION OF THE DRAWINGS

The claimed subject matter may be understood by reference to the following description taken in conjunction with the accompanying drawings, in which like reference numerals identify like elements, and in which:

FIG. 1 is a schematic view of a natural gas system comprising multiple compressor packages connected to corresponding multiple emissions management modules wherein emissions are added to a natural gas stream upstream of the compressor packages according to one embodiment;

FIG. 2 is a schematic view of a natural gas system comprising multiple compressor packages connected to a common emissions management module wherein emissions are added to a natural gas stream upstream of the compressor packages according to one embodiment;

FIG. 3 is a schematic view of a natural gas system comprising multiple compressor packages connected to a common emissions management module wherein emissions are added to a natural gas stream before it is consumed by the drivers in the compressor packages according to one embodiment;

FIG. 4 is a schematic view of a natural gas system comprising multiple compressor packages connected to a common emissions management module wherein emissions are added to a natural gas stream before it is consumed by the drivers in the compressor packages and/or routed to a hydrocarbon processing component according to one embodiment;

FIG. 5 is a schematic view of a compressor package connected to a common emissions management module further comprising a cooling system for cooling components of the compressor package and a circulator compressor in the emissions management module according to one embodiment;

FIG. 6 is a schematic view of a compressor package connected to a common emissions management module further comprising a cooling system for cooling components of the compressor package and a circulator compressor having an external power source in the emissions management module according to one embodiment;

FIG. 7 is a schematic view of a compressor package connected to a common emissions management module further comprising a cooling system for cooling components of the compressor package and a circulator compressor in the emissions management module powered by a generator in the cooling system according to one embodiment;

FIG. 8 is a schematic view of an embodiment of a compressor package and an emissions management module of the natural gas system of FIG. 1;

FIG. 9 is a schematic view of an embodiment of a compressor package and an emissions management module of the natural gas system of FIG. 1;

FIG. 10 is a schematic view of an embodiment of a compressor package and an emissions management module of the natural gas system of FIG. 1;

FIG. 11 is a schematic view of an embodiment of a compressor package and an emissions management module of the natural gas system of FIG. 1;

FIG. 12 is a schematic view of an embodiment of a compressor package and an emissions management module of the natural gas system of FIG. 1; and

FIG. 13 is a flowchart of an embodiment of a method for capturing emissions from a compressor package of a natural gas system.

While the disclosed process and system are susceptible to various modifications and alternative forms, the drawings illustrate specific embodiments and/or aspects herein described in detail by way of example. It should be understood, however, that the description herein of a specific embodiment is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

The following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure. Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

### Definitions

As used herein, “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As used herein, “couple” or “couples” is intended to mean either an indirect or direct connection. Thus, if a first device couples to a second device, that connection may be through a direct connection of the two devices, or through an indirect connection that is established via other devices, components, nodes, and connections.

As used herein, “emissions” is defined as referring to the emission or release of a hydrocarbon (e.g., methane and other materials) bearing material from a component of a natural gas system, including a compressor package of a natural gas system. As described above, one potential source for the leakage and/or venting of emissions, including greenhouse gases such as natural gas and/or its combustion byproducts, to the environment are compressor packages of natural gas systems. Emissions may contain both hydrocarbons and other materials such as carbon dioxide. Additionally, emissions may either be accidental in the form of leaks or inadvertent releases of hydrocarbon bearing materials from a component of the natural gas system, as well as releases of hydrocarbon bearing materials by design from a component of the natural gas system, such as what typically occurs during the “blowdown” of a compressor package of conventional natural gas systems.

As used herein, “fluidly connected,” “fluid communication,” or similar language means that a fluid path exists between two elements, whether directly (e.g., via a conduit, pipe, channel, or passage) or indirectly (e.g., through one or more intermediate components), such that fluid can flow or be communicated from one to the other.

As used herein, “including” and “comprising” are used in an open-ended fashion, and thus should be interpreted to mean “including, but not limited to . . . ”

As used herein, “kPaa” means atmospheric kilopascals.

As used herein, “MPaa” means atmospheric megapascals.

As used herein, “periodically” means that a device is caused to turn on and off in response to one or more control signals, such as reaching a pressure threshold, reaching a temperature threshold, satisfying a time interval, meeting another setpoint condition, or a combination thereof, such that the device does not operate continuously but instead in a repeating on/off manner rather than randomly or continuously. In the context of circulator (discussed in more detail below) as the device, periodic operation (non-continuous) of the circulator is independent of operation of the compressor package producing the pressurized flow of natural gas. The circulator operates periodically while the compressor package operates continuously. Periodic operation means non-continuous operation in that the circulator alternates between operating periods and non-operating periods with no requirement that the timespan of any two operating periods are equivalent, no requirement that the timespan of any two non-operating periods are equivalent, and no requirement that the timespan of any operating period is equivalent to any non-operating period.

As used herein, “psia” means atmospheric pounds per square inch.

As used herein, “vol %,” in the context of contents of the equipment being cleared, means volume percent, wherein volume percent removed is calculated as ((V_{b-eq}−V_{a-eq})/V_{b-eq})×100, wherein V_{b-eq} is the total equivalent volume of gas in the relevant equipment prior to clearing, V_{a-eq} is the total equivalent volume of gas in the relevant equipment after clearing, and equivalent volume of gas means the volume of gas at actual temperature and pressure normalized to an equivalent volume at 101 kPaa and 23 °C.

### Natural Gas System Emissions

Typically, natural gas (again, predominantly comprising methane) and/or other greenhouse gases may leak or be vented from various sources of the compressor package. Typically, a majority of the greenhouse gases produced by a compressor package is the carbon dioxide produced from the exhaust of the natural gas engine of the compressor package as a result of the combustion process. However, in addition to the carbon dioxide vented by the exhaust of the natural gas engine as a result of the combustion process, compressor packages may also release emissions in other ways. For example, some compressor packages include controls (e.g., control louvers, liquid level controllers, etc.) which use natural gas as their motive power. These natural gas controls of the compressor package may vent natural gas during operation (either continuously or intermittently). Additionally, compressor packages may (accidentally or by design) vent emissions in the form of natural gas escaping from the packing cases of the piston rods of the compressor of the compressor package. As a further example, when the compressor package is shutdown due to, for example, the performance of maintenance, the natural gas present within the compressor package is conventionally vented via a blowdown system of the compressor package to either a flare or the atmosphere.

Various systems have been developed to capture one or more of these sources of greenhouse gases emitted by compressor packages so as to minimize the amount of emissions produced by the compressor package during operation. For example, systems have been developed to capture emissions in the form of natural gas vented from the compressor package (e.g., from the blowdown system of the compressor package) and to route the captured natural gas to a vapor recovery unit of the natural gas system comprising the compressor package. The captured emissions may then be stored and/or flared whereby the natural gas is combusted prior to being released to the environment. However, these recovery systems require the building of additional stationary infrastructure in the form of tank batteries, compressors, and/or flares tailored to the specific natural gas system, increasing the overall cost associated with building and operating the natural gas system. Additionally, the flaring of captured emissions typically undesirably produces at least some greenhouse gases which are vented to the atmosphere.

### Conventional Emissions Recovery

Alternatively, some conventional recovery systems route emissions captured from the compressor package directly to a fuel or air intake of the natural gas engine of the compressor package. For example, some conventional recovery systems may take advantage of the vacuum produced by the suction-side of the natural gas engine (e.g., the suction produced by a turbocharger of the natural gas engine) and thus route the captured emissions directly to the natural gas engine. Thus, some conventional recovery systems route captured emissions directly to the natural gas engine such that the natural gas engine itself may provide the motive force for conveying the emissions to the natural gas engine. The term “directly” refers in this context to the routing of the captured emissions to the natural gas engine at a location downstream from equipment of the natural gas engine for conditioning (e.g., filtering equipment, pressure control equipment) the fuel gas supplied to the natural gas engine prior to being consumed by the engine. However, it may be undesirable for a variety of reasons to route captured emissions directly to the natural gas engine of the compressor package as a fuel source for the natural gas engine. For example, the captured emissions may damage or otherwise reduce the reliability of the natural gas engine without being properly conditioned prior to being consumed by the natural gas engine. The captured emissions may also interfere with the operation of the control system used to operate the natural gas engine when the captured emissions are received by the natural gas engine downstream from equipment used to monitor the flow of fuel gas to the natural gas engine. In addition, it is not possible to utilize captured emissions as a fuel source in applications where an electric motor, rather than a natural gas engine, is utilized as the driver of the compressor package. Further, emissions captured from a blowdown system of the compressor package typically cannot be immediately utilized as a fuel source by the engine given that the engine of the compressor package is typically shut-off during the blowdown process.

Circulation of gases using a gas ejector comprising a motive nozzle, suction chamber, and diffuser is known. High-pressure gas expands through the nozzle, creating velocity that entrains a secondary stream. The mixed flow passes through the diffuser, where velocity is recovered as pressure. Expansion induces Joule-Thomson cooling, sharply reducing temperature. During continuous operation, water vapor and/or or condensable hydrocarbons in a natural gas motive stream have been found to cross dew or freezing points, causing cryogenic deposition (freezing fouling) wherein ice and/or solid hydrocarbon buildup can obstruct the nozzle and/or diffuser, impairing entrainment and discharge. Mitigation involves upstream drying, motive gas preheating, or design strategies to reduce deposition risk.

### Emissions Management Module Integration Into Natural Gas Systems

Accordingly, embodiments described herein include natural gas systems comprising one or more emissions management modules configured to capture emissions from one or more compressor packages, and to circulate those captured emissions to one or more component of the natural gas system. Embodiments of emissions management modules disclosed herein may be self-contained and modularized and thus easily integrated into pre-existing natural gas systems with minimal additional work required. Particularly, the emissions management module may be connected to one or more separate compressor packages of the natural gas system whereby the emissions management module may capture emissions from a variety of different emissions sources of the one or more compressor packages. Embodiments of emissions management modules disclosed herein may advantageously connect to multiple compressor packages of a pre-existing natural gas system to capture and process emissions from the plurality of compressor packages simultaneously in parallel. The incorporation of self-contained emissions management modules into pre-existing natural gas systems may eliminate the need for additional, potentially emissions-producing infrastructure to the natural gas system, such as tank batteries and/or flares for processing the captured emissions. Moreover, the emissions captured by the subject emissions management modules do not interfere with the operation of the engine.

As will additionally be discussed herein, embodiments of emissions management modules disclosed herein may capture emissions from various sources of a compressor package. For instance, emissions management modules described herein may capture instrumentation and/or control emissions (e.g., liquid level controllers, louvers controllers, control valves), piston rod packing system emissions, and/or blowdown system emissions. Additionally, embodiments of emissions management modules disclosed herein may include a vapor recovery unit (VRU) used to periodically circulate the captured emissions from the emissions management module to a component of the natural gas system. In some embodiments, the VRU may comprise one or more compressors. However, in other embodiments, the VRU may comprise one or more ejectors or other gas circulators driven by the flow of motive natural gas processed by the compressor package, thereby eliminating the need for a mechanically driven compressor.

As will further be discussed herein, embodiments of emissions management modules may periodically return the captured emissions to the compressor package (or other component of the natural gas system) at a variety of locations. For example, embodiments of emissions management modules disclosed herein may return captured emissions to a suction of one or more compressor packages whereby the captured emissions may be compressed by the compressor of the one or more of the compressor packages. Additionally, embodiments of emissions management modules disclosed herein may return captured emissions to the compressor package or other hydrocarbon processing component of the natural gas system as fuel gas to be consumed by the compressor package (e.g., consumed by a driver of the compressor package) or other hydrocarbon processing component (e.g., consumed by a burner assembly of the component). As used herein, the term “hydrocarbon processing component” is defined as referring to any component of a natural gas system which receives a process stream of hydrocarbons (e.g., oil, natural gas) and may include various types of equipment including boilers, furnaces, heat exchangers, separators, compressors (including compressor packages), and other equipment. As understood in the oil and gas industry, processing equipment, as that term is characterized here, may also be referred to as production equipment and, as such, references to the former are intended to be inclusive of the latter. As will be discussed further herein, emissions management modules disclosed herein, when utilizing captured emissions as a fuel source for a natural gas engine of the compressor package, return the captured emissions to the compressor package at a location upstream from fuel gas conditioning equipment of the natural gas engine so that the returned captured emissions do not damage or otherwise hinder the operation of the natural gas engine.

### Natural Gas Systems

In one aspect, this disclosure is directed to a natural gas system incorporating an emissions management module (EMM; described in more detail below). In some embodiments, the natural gas system comprises a process suction conduit, a compressor package, a process discharge conduit, and an EMM. The compressor package is connected downstream of the process suction conduit. The compressor package is configured to receive a flow of natural gas from the process suction conduit and to increase a pressure of the flow of natural gas whereby the flow of natural gas is discharged from the compressor package as a pressurized flow of natural gas. The process discharge conduit is connected downstream of the compressor package and is configured to receive the flow of natural gas discharged from the compressor package. The EMM is coupled to the compressor package and is configured to capture emissions from the compressor package. The EMM comprises a vapor recovery unit (VRU) configured to periodically circulate the captured emissions from the VRU to an emissions discharge conduit.

In some embodiments of the natural gas system, the EMM further comprises an emissions inlet conduit and a VRU control system, and the VRU comprises at least one circulator. The periodic circulation of the captured emissions from the VRU to the emissions discharge conduit is enabled by the VRU control system. The VRU control system activates the circulator to withdraw the captured emissions from the emissions inlet conduit when a pressure in the inlet conduit reaches an upper threshold value. The VRU control system circulates the withdrawn captured emissions from the emissions inlet conduit to the emissions discharge conduit, thereby reducing the pressure in the emissions inlet conduit. The VRU control system deactivates the circulator to terminate withdrawal of the captured emissions from the emissions inlet conduit when the pressure in the emissions inlet conduit reaches a lower threshold value. In some embodiments, the VRU control system deactivates the circulator if the pressure in the emissions inlet conduit does not reach the lower threshold within a preselected time period.

### High Pressure Emissions Sources

In some embodiments, the high-pressure emissions inlet conduit fluidly connects the VRU to an emissions source having an initial pressure greater than the upper threshold value or alternatively greater than the operating pressure of the component or system of the natural gas system to which captured emissions are to be conveyed. In some embodiments where emissions are collected from one or more high pressure sources, the ratio of the upper threshold value of pressure in the emissions inlet conduit to the pressure in the emissions discharge conduit is less than or equal to 2, less than or equal to 1.8, or less than or equal to 1.5. In some embodiments where emissions are collected from one or more high pressure sources, the ratio of the upper threshold value of pressure in the emissions inlet conduit to the pressure in the emissions discharge conduit is greater than or equal to 1, greater than or equal to 1.1, or greater than or equal to 1.2. In some embodiments where emissions are collected from one or more high pressure sources, the ratio of the upper threshold value of pressure in the emissions inlet conduit to the pressure in the emissions discharge conduit is in a range of from 1 to 2, from 1.1 to 1.8, or from 1.2 to 1.5. When the ratio of the upper threshold value of pressure in the emissions inlet conduit to the pressure in the emissions discharge conduit is less than 1, flow from the high pressure disposition being cleared to the emissions discharge conduit would stop. Activation of the circulator induces flow from the high pressure disposition being cleared into the emissions discharge conduit when the pressure of high pressure disposition being cleared has been reduced to a pressure less than the pressure of the emissions discharge conduit. When the ratio of the upper threshold value of pressure in the emissions inlet conduit to the pressure in the emissions discharge conduit is greater than 2, gas from the high pressure disposition being cleared to the emissions discharge conduit flows without the need for the circulator. The captured emissions flow from the emissions source to the emissions discharge conduit based on differential pressure until the pressure in the emissions inlet conduit reaches the upper threshold value. When the pressure in the emissions inlet conduit reaches the upper threshold value, the circulator is activated to circulate captured emissions to the emissions discharge conduit, thereby reducing the pressure in the emissions inlet conduit.

In some embodiments, the captured emissions comprise emissions from an emissions source at a pressure greater than or equal to the pressure of the upper threshold of the control range. In some embodiments, the captured emissions comprise emissions from an emissions source at a pressure greater than or equal to 30 psia (207 kPaa), greater than or equal to 50 psia (345 kPaa), greater than or equal to 100 psia (689 kPaa), greater than or equal to 250 psia (1.7 MPaa), or greater than or equal to 500 psia (3.4 MPaa). In some embodiments, the captured emissions comprise emissions from an emissions source at a pressure less than or equal to 10,000 psia (68.9 MPaa), less than or equal to 5,000 psia (34.5 MPaa), less than or equal to 2,500 psia (17.2 MPaa), less than or equal to 1,500 psia (10.3 MPaa), or less than or equal to 1,000 psia (6.9 MPaa). In some embodiments, the captured emissions comprise emissions from an emissions source at a pressure in a range of from 30 psia (207 kPaa) to 10,000 psia (68.9 MPaa), from 50 psia (345 kPaa) to 5,000 psia (34.5 MPaa), from 100 psia (689 kPaa) to 2,500 psia (17.2 MPaa), from 250 psia (1.7 MPaa) to 1,500 psia (10.3 MPaa), or from 500 psia (3.4 MPaa) to 1,000 psia (6.9 MPaa).

In some embodiments, the pressure of the high pressure source being cleared is reduced to the upper threshold pressure without the need for activating the circulator. After the circulator is activated, the pressure of the high pressure source being cleared is reduced to the lower threshold pressure. In some embodiments, the pressure of the high pressure source being cleared is reduced to the same pressure as the pressure to which the suction tank is reduced when the circulator is deactivated.

In some embodiments, the captured emissions comprise emissions related to shutdown of a compressor package, shutdown of a hydrocarbon processing component in the natural gas system other than the compressor package, or a combination thereof.

In some embodiments, the captured emissions comprise emissions from a blowdown system of a compressor package, a blowdown system of the natural gas system other than the blowdown system of the compressor package, or a combination thereof.

### Low Pressure Emissions Sources

In some embodiments, the low pressure-emissions inlet conduit fluidly connects to an emissions source having an initial pressure less than the upper threshold value or alternatively less than the operating pressure of the component or system of the natural gas system to which captured emissions are to be conveyed. In further embodiments where emissions are collected from one or more low pressure sources, the upper threshold value is in a range of from twice the lower threshold value to less than the pressure in the emissions discharge conduit. The captured emissions accumulate in the emissions inlet conduit until the pressure in the emissions inlet conduit reaches the upper threshold value. In some embodiments, the inlet conduit further comprises a suction tank.

In some embodiments, the low-pressure emissions inlet conduit further comprises a suction tank.

In some embodiments, the VRU is configured to maintain the emissions low-pressure emissions inlet conduit at a pressure less than or equal to 1 atmosphere.

In some embodiments, the captured emissions comprise emissions from an emissions source at a pressure less than or equal to the pressure of the upper threshold of the control range. In some embodiments, the captured emissions comprise emissions from an emissions source at a pressure less than or equal to 30 psia (207 kPaa). In some embodiments, the captured emissions comprise emissions from an emissions source at a pressure greater than or equal to 14.7 psia (101 kPaa).

In some embodiments, the captured emissions comprise emissions from a compressor package when in operation, a hydrocarbon processing component in the natural gas system in operation other than the compressor package, or a combination thereof.

In some embodiments, the captured emissions comprise emissions from a seal system of a compressor package, a vent system of the compressor package, a vent system of the natural gas system other than the vent system of the compressor package, or a combination thereof.

In some embodiments, a natural gas processing facility includes one or more pneumatically actuated valves operatively coupled to controllers configured to use pressurized natural gas as a motive fluid. The natural gas may be supplied from a plant gas source through one or more filters and pressure regulators to a controller, positioner, solenoid, or pilot valve, which selectively directs the natural gas to an actuator chamber of a control valve, shutdown valve, or isolation valve to effect opening, closing, or throttling movement. Upon repositioning of the relevant valve, spent motive gas exhausted from the actuator and/or controller can be routed to a vent header, which is subsequently routed to the low-pressure emissions inlet conduit. In some embodiments, similar vent-header routing may be provided for gas-driven pneumatic controllers, positioners, and pumps using natural gas as an actuation medium.

### Emissions Recycle

In some embodiments, the emissions discharge conduit delivers the captured emissions to the process suction conduit, a fuel gas system of the natural gas system, a hydrocarbon processing component that is separate from the compressor package, or a combination thereof.

The emissions discharge conduit of the EMM delivers captured emissions to one or more destination dispositions within the natural gas system, including the process suction conduit, a fuel gas system of the natural gas system, a hydrocarbon processing component separate from the compressor package, or a combination thereof. The EMM may include selectable valves along the emissions discharge conduit and any branch conduits extending therefrom, whereby an operator may direct captured emissions to one or more destination dispositions independently or simultaneously. The selection of destination disposition may be based on the operating pressure of the suction conduit, the availability and pressure of the fuel gas system, and the type and operating pressure of any hydrocarbon processing component present in the natural gas system.

In some embodiments, the emissions discharge conduit delivers captured emissions to the process suction conduit or suction header, where the captured emissions commingle with the process natural gas stream, are received by the compressor, compressed, and discharged to the downstream pipeline as saleable natural gas. This disposition is suited for natural gas systems in which the suction header pressure is within the discharge capability of the VRU circulator. Where the circulator comprises a gas ejector, the maximum achievable discharge pressure is limited by the ejector's nozzle-diffuser geometry and available motive gas pressure; if the suction header pressure exceeds this limit, an alternative disposition should be selected.

In some embodiments, the emissions discharge conduit delivers captured emissions to the fuel gas system at a location upstream from the fuel gas conditioning equipment of the compressor package. In some embodiment the fuel gas conditioning equipment comprises a fuel filter, a liquid separator, and one or more pressure regulators. Delivering captured emissions upstream of the fuel gas conditioner ensures the recovered emissions are filtered and pressure-regulated before reaching the driver, avoiding damage or control interference that could result from routing unconditioned emissions directly to the driver. The VRU provides the compression needed to deliver captured emissions to the fuel header without relying on the driver's turbocharger suction. This disposition is particularly advantageous when the suction header pressure exceeds the ejector's discharge capability, as the fuel gas system typically operates at a lower pressure in high-pressure compression applications.

In some embodiments, the emissions discharge conduit delivers captured emissions to a hydrocarbon processing component such as a boiler, furnace, heat exchanger, separator, pressure vessel, or separate compressor package, via a branch emissions discharge conduit extending to the fuel gas conduit supplying that component. The captured emissions supplement the component's fuel gas supply, reducing the fuel drawn from the primary fuel source. This disposition may be selected when both the suction conduit and the fuel header are at pressures exceeding the VRU circulator's capability, or in addition to other dispositions when the volume of captured emissions warrants distribution among multiple destinations.

In some embodiments, selectable valves along the emissions discharge conduit, branch emissions discharge conduit, and supplemental emissions discharge conduit allow the operator to route captured emissions concurrently to all three destination dispositions. Where the VRU comprises a high-pressure circuit and a low-pressure circuit, the respective discharge conduits of each circuit may be independently routed to the same or different destination dispositions, providing further flexibility in managing captured emissions from high-pressure and low-pressure emission sources simultaneously.

In some embodiments, the circulator comprises a compressor and a motor configured to drive the compressor. In some embodiments, the EMM comprises a support structure, and a power source supported on the support structure and configured to power the motor of the circulator. In some embodiments, the motor of the circulator is configured to receive electrical energy from an electrical power grid. In some embodiments, the compressor package comprises a cooling system comprising a fan and a driveshaft driven by the compressor and configured to rotate the fan. In some embodiments, the compressor package comprises an electrical power source comprising an electrical generator and a driveshaft driven by the compressor and configured to drive the electrical generator.

In some embodiments, the circulator comprises a gas ejector powered by a motive fluid flow. In some embodiments, the motive fluid flow comprises a flow of natural gas from the process discharge conduit.

### EMM Configurations

In some embodiments, the EMM comprises a support structure on which the VRU is supported, and the support structure further comprises a road transportable skid.

In some embodiments, a plurality of the compressor packages arranged in parallel with respect to each other, and a plurality of the EMMs, wherein each of the EMMs is associated with one of the plurality of the compressor packages.

In some embodiments, the VRU comprises a high-pressure circuit comprising a high-pressure gas circulator configured to receive a first stream of emissions from the compressor package and a low-pressure circuit comprising a low-pressure gas circulator configured to receive a second stream of emissions from the compressor package. In some embodiments, the high-pressure gas circulator comprises a high-pressure compressor or a high-pressure gas ejector, and the low-pressure gas circulator comprises a low-pressure compressor or a low-pressure gas ejector.

In some embodiments, one of the high-pressure gas circulator and the low-pressure gas circulator discharges into a fuel gas system of the compressor package, a fuel gas system of the natural gas system other than the fuel gas system of the compressor package, or a combination thereof.

In some embodiments, the compressor package comprises a first compressor package of a plurality of compressor packages of the natural gas system, wherein the EMM is connected to the plurality of compressor packages in parallel whereby the emissions management module is configured to the capture emissions from each of the plurality of compressor packages.

### Emissions Management Modules

In another aspect, this disclosure is directed to an emissions management module (EMM). In some embodiments, the EMM for a natural gas system comprises a support structure, a high-pressure emissions inlet conduit supported on the support structure, and a low-pressure emissions inlet conduit supported on the support structure. The high-pressure emissions inlet conduit is configured to receive a high-pressure stream of emissions from the natural gas system, and the low-pressure emissions inlet conduit is configured to receive a low-pressure stream of emissions from the natural gas system. The EMM further comprises a vapor recovery unit (VRU) supported on the support structure and connected to both the high-pressure emissions inlet conduit and the low-pressure emissions inlet conduit. The EMM further comprises a high-pressure emissions discharge conduit and a low-pressure emissions discharge conduit connected to the VRU, wherein the VRU is configured to periodically circulate the high-pressure stream of emissions and/or the low-pressure stream of emissions from the VRU to a component of the natural gas system. The method for capturing emissions using an EMM is described in more detail below.

In some embodiments the EMM further comprises a VRU control system, and the VRU comprises a circulator. The periodic circulation of the captured emissions from the VRU to the low-pressure emissions discharge conduit or the high-pressure emissions discharge conduit is enabled by the VRU control system. The VRU control system activates the circulator to withdraw the captured emissions from the low-pressure emissions inlet conduit or the high-pressure emissions inlet conduit, respectively, when a pressure in the low-pressure emissions inlet conduit or the high-pressure emissions inlet conduit, respectively, reaches an upper threshold value. The VRU control system circulates the withdrawn captured emissions from the low-pressure emissions inlet conduit or the high-pressure emissions inlet conduit, respectively, to the low-pressure emissions discharge conduit or the high-pressure emissions discharge conduit, respectively, thereby reducing the pressure in the low-pressure emissions inlet conduit or the high-pressure emissions inlet conduit, respectively. The VRU control system deactivates the circulator to terminate withdrawal of the captured emissions from the low-pressure emissions inlet conduit or the high-pressure emissions inlet conduit, respectively, when the pressure in the low-pressure emissions inlet conduit or the high-pressure emissions inlet conduit, respectively, reaches a lower threshold value. In further embodiments, the VRU control system deactivates the circulator if the pressure in the low-pressure emissions inlet conduit or the high-pressure emissions inlet conduit, respectively, does not reach the lower threshold within a preselected time period.

In some embodiments, the programming logic for control of a circulator is typically implemented in a programmable logic controller (PLC; an industrial computer designed for real-time control) or in a distributed control system (DCS; a networked control platform with built-in operator and engineering tools). Pressure is monitored upstream of a closed valve in the inlet conduit upstream of the inlet to the circulator. The pressure signal from a transmitter is scaled and lightly filtered in the PLC or DCS to smooth out noise. A control range is defined by an upper threshold pressure and a lower threshold pressure. The upper threshold pressure value initiates a start and a lower threshold that can initiate a stop. The control system itself creates hysteresis by the way the logic is programmed in the PLC or DCS. By requiring the emissions inlet pressure to exceed or fall below the upper threshold (i.e., low pressure emissions inlet pressure increases to the upper threshold and high pressure emissions inlet pressure approaches the control range from a pressure above the upper threshold) for a certain time before starting and then to fall below the lower threshold for a certain time before stopping, the system avoids rapid on-off cycling around a single setpoint. An on-delay timer requires the pressure to remain above the high threshold for a set duration before a start is allowed, while an off-delay timer requires the pressure to remain below the low threshold for a defined time before a stop occurs. In parallel, the PLC or DCS can also evaluate a schedule block, comparing current time against configured operating windows to generate start requests independent of pressure.

In some embodiments, the control logic governing operation of the VRU and associated emissions management module is organized into a simple state machine that cycles through five discrete states: stopped, starting, running, stopping, and tripped. The PLC or DCS issues a start command when a valid start condition exists and all permissives are satisfied, where “permissives” refers to the set of conditions that must each be satisfied before a piece of equipment is allowed to start or remain running. Once a start command is issued, the system waits for feedback confirming that the equipment is running and then holds the system in the running state until a stop condition is triggered. A stop is initiated when any one of the following occurs: the emissions inlet pressure remains at or below the lower threshold for a sustained period, an operator manually requests a stop, or a scheduled stop time is reached. Upon any such trigger, the logic issues a stop command and transitions to the stopping state, where it remains until feedback confirms the stop. If any interlock or safety trip condition arises, that condition overrides all other logic and immediately forces the system into the tripped state, which remains latched until reset by an operator. To prevent rapid or unstable on/off cycling, the control logic employs persistence timers. An on-delay timer requires the emissions inlet pressure to remain at or above the upper threshold for a preselected minimum duration before a start command may be issued, and this minimum duration may be, for example, greater than or equal to 1 minute, greater than or equal to 2 minutes, greater than or equal to 5 minutes, greater than or equal to 10 minutes, greater than or equal to 15 minutes, or greater than or equal to 30 minutes. Likewise, an off-delay timer requires the emissions inlet pressure to remain at or below the lower threshold for a preselected minimum duration before a stop command may be issued, and this minimum duration may similarly be, for example, greater than or equal to 1 minute, greater than or equal to 2 minutes, greater than or equal to 5 minutes, greater than or equal to 10 minutes, greater than or equal to 15 minutes, or greater than or equal to 30 minutes. By contrast, the deactivation safety timeout operates as a maximum duration requirement: the VRU control system will deactivate the circulator if the pressure in the emissions inlet conduit fails to reach the lower threshold within a preselected maximum duration following startup, thereby preventing prolonged operation under abnormal or stalled conditions, and this maximum duration may be, for example, less than or equal to 1 minute, less than or equal to 2 minutes, less than or equal to 5 minutes, less than or equal to 10 minutes, less than or equal to 15 minutes, or less than or equal to 30 minutes. In parallel, the PLC or DCS may evaluate a schedule block that compares the current time against configured operating windows and generates start or stop requests independently of pressure conditions. Together, the use of hysteresis, persistence timers operating as minimum duration requirements, a deactivation safety timeout operating as a maximum duration requirement, schedule-based logic, and explicit state transitions ensures that equipment starts only under stable and sustained conditions, stops in a controlled and deliberate manner, and responds immediately to safety demands.

### High Pressure System

In some embodiments of the natural gas system, the emissions inlet conduit fluidly connects the VRU to an emissions source having an initial pressure greater than the upper threshold value or alternatively greater than the operating pressure of the component or system of the natural gas system to which captured emissions are to be conveyed (“destination disposition”).

In some embodiments, the equipment to be cleared and depressurized comprises one or more compressor packages and/or one or more components of a natural gas system other than a compressor package. The equipment to be cleared is connected to an upstream portion of the blowdown system, while a downstream portion of the blowdown system is connected to the emissions inlet conduit of the EMM. One of ordinary skill in the art would recognize how to design and implement a network of conduits and valves required to facilitate the flow paths as described herein. The equipment clearing process is conducted in two phases, the pressure-driven phase and the circulator-driven phase.

In the pressure-driven phase, the equipment to be depressurized and cleared initially starts the clearing process at a first pressure. One or more valves are opened to fluidly connect the equipment being depressurized to the blowdown system and the blowdown system to the destination disposition. In some embodiments, the equipment being depressurized is in fluid communication with the destination disposition through the blowdown system while bypassing the VRU of the EMM. The VRU is bypassed by a bypass conduit providing a direct connection between the emissions inlet conduit and the emissions discharge conduit of the EMM, while valves upstream and downstream of the VRU isolate the VRU from the flow of captured emissions from the equipment being depressurized. In some embodiments, the emissions inlet conduit is fluidly connected to the discharge conduit through the VRU while the circulator of the relevant VRU is not energized (i.e., the circulator of the VRU does not provide any motive force to enhance the flow of captured emissions), thereby eliminating the need for a bypass conduit. The flow of captured emissions from the equipment being depressurized, whether through a bypass conduit or through the relevant VRU, is caused solely by the higher pressure in the equipment being depressurized and the lower pressure of the destination disposition. One of ordinary skill in the art would recognize how to design and implement an appropriate arrangement of valves, pressure control systems, flow control systems and/or other well-known equipment to control the flow of captured emissions from the equipment being cleared to the destination disposition as the pressure in the equipment being cleared is reduced from the first pressure and approaches the pressure set as the upper threshold of the control range. The circulator-driven phase is implemented when the pressure in the emissions inlet conduit is equal to or substantially equal to the upper threshold of the control range. In some embodiments, the ratio of the upper threshold of the control range to the operating pressure of the destination disposition is less than or equal to 2, less than or equal to 1.8, or less than or equal to 1.5. In some embodiments where emissions are collected from one or more high pressure sources, the ratio of the upper threshold of the control range to the operating pressure of the destination disposition is greater than or equal to 1, greater than or equal to 1.1, or greater than or equal to 1.2. In some embodiments where emissions are collected from one or more high pressure sources, the ratio of the upper threshold of the control range to the operating pressure of the destination disposition is in a range of from 1 to 2, from 1.1 to 1.8, or from 1.2 to 1.5. When the ratio of the upper threshold value of pressure in the emissions inlet conduit to the pressure in the emissions discharge conduit is less than 1, flow from the high pressure disposition being cleared to the emissions discharge conduit would stop. Activation of the circulator induces flow from the high pressure disposition being cleared into the emissions discharge conduit when the pressure of high pressure disposition being cleared has been reduced to a pressure less than the pressure of the emissions discharge conduit. When the ratio of the upper threshold value of pressure in the emissions inlet conduit to the pressure in the emissions discharge conduit is greater than 2, gas from the high pressure disposition being cleared to the emissions discharge conduit flows without the need for the circulator. If the circulator-driven phase is not implemented, flow of the captured emissions will stop when the pressure in the emissions inlet conduit is equal to or substantially equal to the operating pressure of the destination disposition. Backflow from the destination disposition to the emissions inlet conduit is prevented at least by one or more check valves.

The transition from the pressure-driven phase to the circulator-driven phase is initiated when the pressure in the emissions inlet conduit reaches the upper threshold of the control range. When the pressure in the emissions inlet conduit reaches the upper threshold value, the circulator is activated to circulate captured emissions to the emissions discharge conduit, thereby reducing the pressure in the emissions inlet conduit to less than the upper threshold limit, then to less than the operating pressure of the destination disposition. The captured emissions continue to be circulated to the destination disposition until the pressure in the emissions inlet conduit is equal to or substantially equal to the lower threshold of the control range. In some embodiments, the lower threshold pressure is selected to facilitate removal of at least 80 vol %, at least 85 vol %, at least 90 vol %, or at least 95 vol % of the contents of the equipment being cleared and circulation to the destination disposition. The circulator is deactivated when the pressure in the emissions inlet conduit is equal to or substantially equal to the lower threshold of the control range, thereby completing the circulator-driven phase.

A period of operation of the high-pressure system comprises the pressure-driven phase followed by the circulator-driven phase. The high-pressure system operates periodically in that the aforementioned period of operation is repeated with each high pressure emission source cleared and depressurized by the EMM. When a pressure-driven phase begins, various valves are opened or closed to fluidly connect the equipment to be cleared and depressurized and the emissions discharge conduit either through a bypass conduit around the VRU or through the VRU with the circulator de-energized. The desired flow path (i.e., positioning and statuses or valves and circulator) for the pressure-driven phase is facilitated in response to detecting that the equipment to be cleared is at a pressure above the upper threshold pressure of the control range. Transition to the circulator-driven phase is triggered in response to the pressure in the emissions inlet conduit being reduced to be equal to or substantially equal to the upper threshold of the control range as the contents of the equipment are withdrawn. Transition to the pressure-driven phase is triggered in response to fluidly connecting the upstream end of the blowdown system to a new piece of equipment to be cleared and the control system sensing a pressure in the equipment to be cleared greater than the upper threshold of the control range.

In some embodiments, the captured emissions comprise emissions from an emissions source at a pressure greater than or equal to the pressure of the upper threshold of the control range. In some embodiments, the captured emissions comprise emissions from an emissions source at a pressure greater than or equal to 30 psia (207 kPaa), greater than or equal to 50 psia (345 kPaa), greater than or equal to 100 psia (689 kPaa), greater than or equal to 250 psia (1.7 MPaa), greater than or equal to 500 psia (3.4 MPaa). In some embodiments, the captured emissions comprise emissions from an emissions source at a pressure less than or equal to 1,000 psia (6.9 MPaa).

In some embodiments, the captured emissions comprise emissions related to shutdown of the compressor package, shutdown of a hydrocarbon processing component in the natural gas system other than the compressor package, or a combination thereof.

In some embodiments, the captured emissions comprise emissions from a blowdown system of the compressor package, a blowdown system of the natural gas system other than the blowdown system of the compressor package, or a combination thereof.

In some embodiments, the control range for the low-pressure system is the same as the control range for the high-pressure system. In some embodiments, the control range for the low-pressure system is different from the control range for the high-pressure system.

In some embodiments, the upper threshold value for the low-pressure system is the same as the upper threshold value for the high-pressure system. In some embodiments, the upper threshold value for the low-pressure system is different from the upper threshold value for the high-pressure system.

In some embodiments, the lower threshold value for the low-pressure system is the same as the lower threshold value for the high-pressure system. In some embodiments, the lower threshold value for the low-pressure system is different from the lower threshold value for the high-pressure system.

In some embodiments, a circulator in a VRU in a high-pressure system comprises a motor driven compressor.

In some embodiments, a circulator in a VRU in a high-pressure system comprises a gas ejector. In some embodiments, the EMM control system transitions the high-pressure system between the pressure-driven phase and the circulator-driven phase in response to the pressure in the emissions inlet conduit relative to the upper threshold or the lower threshold of the control range. In some embodiments, the EMM control system transitions the high-pressure system from the circulator-driven phase to the pressure-driven phase if the pressure in the emissions inlet conduit has not reached the lower threshold of the control range within a predetermined time period. In some embodiments, the EMM control system transitions the high-pressure system from the circulator-driven phase to the pressure-driven phase if the temperature of the ejector nozzle drops to a minimum threshold temperature. In some embodiments, cryogenic deposition of frozen water vapor and/or frozen hydrocarbon on the ejector internal components is avoided by the EMM control system by switching between the circulator-driven phase and the pressure-driven phase according to the foregoing pressure threshold, time threshold, temperature threshold, or a combination thereof.

The circulator, whether a motor driven compressor or a gas ejector driven by high pressure gas from the discharge of the compressor package, is only operating periodically (during the circulator-driven phase)—i.e., between being energized in response to the emissions inlet conduit pressure being reduced to the upper threshold of the control range and then shutting down in response to the emissions inlet conduit pressure being further reduced to the lower threshold of the control range. When compared to a circulator that runs continuously, this periodic operation of the circulator, whether a motor driven compressor or a gas ejector driven by high pressure gas from the discharge of the compressor package, results in reduced energy consumption and extended equipment lifespan as a result of less cumulative time in operation. When compared to a gas ejector that runs continuously, this periodic operation of a gas ejector driven by high pressure gas from the discharge of the compressor package results in reduced recycle of high-pressure gas and improved service factor by elimination of cryogenic deposition of frozen water vapor and/or frozen hydrocarbon on the ejector internal components equipment lifespan as a result of less cumulative time in operation.

### Low Pressure System

In some embodiments, the emissions inlet conduit fluidly connects the VRU to an emissions source having an initial pressure less than the upper threshold value or alternatively less than the operating pressure of the component or system of the natural gas system to which captured emissions are to be conveyed (“destination disposition”). In further embodiments where emissions are collected from one or more low pressure sources, the upper threshold value is in a range of from twice the lower threshold value to less than the pressure in the emissions discharge conduit. The captured emissions accumulate in the emissions inlet conduit until the pressure in the emissions inlet conduit reaches the upper threshold value. In some embodiments, the inlet conduit further comprises a suction tank.

In some embodiments, low pressure emissions sources comprising one or more continuous or intermittent sources are collected in the emissions inlet conduit and, if present, a suction tank upstream of the emissions inlet conduit while the emissions inlet conduit of the EMM is isolated from the VRU of the EMM. Management of captured emissions from low pressure sources is conducted in two phases, the storage phase and the drawdown phase. During the storage phase, pressure in the emissions inlet conduit and the suction tank increases as the inventory of captured emissions builds in the emissions inlet conduit and the suction tank (when present). Transition to the drawdown phase is initiated when the pressure of the captured emissions in the emissions inlet conduit and the suction tank increases to be equal to or substantially equal to the upper threshold pressure of the control range. During the drawdown phase, the emissions inlet conduit is fluidly connected to the emissions discharge conduit through the VRU of the EMM, and the circulation of the VRU is energized to circulate captured emissions to a destination disposition, thereby reducing the inventory and correspondingly the pressure in the emissions inlet conduit and the suction tank. In some embodiments, the upstream end of the emissions inlet conduit is isolated from the low-pressure emissions sources. In some embodiments, the upstream end of the emissions inlet conduit remains fluidly connected to the low-pressure emissions sources, wherein the drawdown rate exceeds the inventory build rate of captured emissions. When the pressure in the emissions inlet conduit and the suction tank is reduced to be equal to or substantially equal to the lower threshold pressure of the control range, the circulator is deenergized. In some embodiments, when the circulator is deactivated, the discharge of the VRU is isolated from the emissions inlet conduit and the suction tank (when present) to prevent backflow from the emissions discharge conduit to the VRU by means such as but not limited to a check valve. One of ordinary skill in the art would recognize how to design and implement a network of conduits and valves required to facilitate the flow paths as described herein.

A period of operation of the high-pressure system comprises the storage phase and the drawdown phase. The low-pressure system operates periodically in that the aforementioned period of operation is repeated starting the drawdown phase in response to the pressure in the emissions inlet conduit reaching the upper threshold of the control range and starting the storage phase in response to the pressure in the emissions inlet conduit reaching the lower threshold of the control range. In some embodiments, various valves are opened or closed to fluidly connect the emissions inlet conduit to the emissions discharge conduit through the circulator and the circulator of the VRU is energized to begin withdrawal of the captured emissions from the emissions inlet conduit and the suction tank in an automated manner by a control system in response to the pressure in the emissions inlet conduit and the suction tank increasing to be equal to or substantially equal to the upper threshold value of the control range. Correspondingly, various valves are opened or closed to fluidly isolate the emissions inlet conduit to the emissions discharge conduit and the circulator of the VRU is de-energized to allow inventory of the captured emissions to build up in the emissions inlet conduit and the suction tank in an automated manner by a control system in response to the pressure in the emissions inlet conduit and the suction tank increasing to be equal to or substantially equal to the lower threshold value of the control range.

In some embodiments, the VRU is configured to maintain the emissions inlet conduit at a pressure less than or equal to 1 atmosphere.

In some embodiments, the captured emissions comprise emissions from an emissions source at a pressure less than or equal to the pressure of the upper threshold of the control range. In some embodiments, the captured emissions comprise emissions from an emissions source at a pressure less than or equal to 30 psia (207 kPaa). In some embodiments, the captured emissions comprise emissions from an emissions source at a pressure greater than or equal to 14.7 psia (101 kPaa).

In some embodiments, the captured emissions comprise emissions from the compressor package when in operation, a hydrocarbon processing component in the natural gas system in operation other than the compressor package, or a combination thereof.

In some embodiments, the captured emissions comprise emissions from a seal system of the compressor package, a vent system of the compressor package, a vent system of the natural gas system other than the vent system of the compressor package, or a combination thereof.

In some embodiments, a circulator in a VRU in a high-pressure system comprises a motor driven compressor.

In some embodiments, a circulator in a VRU in a storage system comprises a gas ejector. In some embodiments, the EMM control system transitions the storage system between the pressure-driven phase and the circulator-driven phase in response to the pressure in the emissions inlet conduit relative to the upper threshold or the lower threshold of the control range. In some embodiments, the EMM control system transitions the storage system from the circulator-driven phase to the pressure-driven phase if the pressure in the emissions inlet conduit has not reached the lower threshold of the control range within a predetermined time period. In some embodiments, the EMM control system transitions the storage system from the circulator-driven phase to the pressure-driven phase if the temperature of the ejector nozzle drops to a minimum threshold temperature. In some embodiments, cryogenic deposition of frozen water vapor and/or frozen hydrocarbon on the ejector internal components is avoided by the EMM control system by switching between the circulator-driven phase and the pressure-driven phase according to the foregoing pressure threshold, time threshold, temperature threshold, or a combination thereof.

The circulator, whether a motor driven compressor or a gas ejector driven by high pressure gas from the discharge of the compressor package, is only operating periodically (during the drawdown phase)—i.e., between being energized in response to the emissions inlet conduit pressure being increased to the upper threshold of the control range and then shutting down in response to the emissions inlet conduit pressure being reduced to the lower threshold of the control range. When compared to a circulator that runs continuously, this periodic operation of the circulator, whether a motor driven compressor or a gas ejector driven by high pressure gas from the discharge of the compressor package, results in reduced energy consumption and extended equipment lifespan as a result of less cumulative time in operation. When compared to a gas ejector that runs continuously, this periodic operation of a gas ejector driven by high pressure gas from the discharge of the compressor package results in reduced recycle of high-pressure gas and improved service factor by elimination of cryogenic deposition of frozen water vapor and/or frozen hydrocarbon on the ejector internal components equipment lifespan as a result of less cumulative time in operation.

### Emissions Recycle

In some embodiments, the low-pressure emissions discharge conduit and/or the high-pressure emissions discharge conduit delivers the captured emissions to a hydrocarbon processing component in the natural gas system operating at a pressure less than or equal to the pressure of the upper threshold of the control range. In some embodiments, the hydrocarbon processing component in the natural gas system operating at a pressure less than or equal to 30 psia (207 kPaa). In some embodiments, the hydrocarbon processing component in the natural gas system operating at a pressure greater than or equal to 14.7 psia (101 kPaa).

In some embodiments, the low-pressure emissions discharge conduit and/or the high-pressure emissions discharge conduit delivers the captured emissions to a process suction conduit of a compressor package, a fuel gas system of the natural gas system, a hydrocarbon processing component that is separate from the compressor package, or a combination thereof.

In some embodiments, the circulator comprises a compressor and a motor configured to drive the compressor. In some embodiments, the EMM further comprises a power source supported on the support structure and configured to power the motor of the circulator. In some embodiments, the motor of the circulator is configured to receive electrical energy from an electrical power grid.

In some embodiments, the circulator comprises a gas ejector powered by a motive fluid flow. In some embodiments, the motive fluid flow comprises a flow of natural gas from a process discharge conduit of a compressor package.

In some embodiments, the high-pressure gas circulator and/or the low-pressure gas circulator discharges into a fuel gas system of a compressor package, a fuel gas system of the natural gas system other than the fuel gas system of the compressor package, or a combination thereof.

### EMM Configurations

In some embodiments of the EMM, the EMM comprises a support structure on which the VRU is supported, and the support structure comprises a road transportable skid.

In some embodiments, the VRU comprises a high-pressure circuit comprising a high-pressure gas circulator configured to receive a first stream of emissions from the compressor package and a low-pressure circuit comprising a low-pressure gas circulator configured to receive a second stream of emissions from the compressor package.

In some embodiments, the high-pressure gas circulator comprises a high-pressure compressor or a high-pressure gas ejector.

In some embodiments, the low-pressure gas circulator comprises a low-pressure compressor or a low-pressure gas ejector.

### Methods for Capturing Emissions

In another aspect, this disclosure is directed to a method for capturing emissions in a natural gas system. The method described herein is applicable to operation of the natural gas systems and/or EMMs as described above. In some embodiments, the method for capturing emissions from a compressor package of a natural gas system comprises transporting a flow of natural gas from a process suction conduit of the natural gas system to a compressor package of the natural gas system. The compressor package increases the pressure of the flow of natural gas received from the process suction conduit and discharges the flow of natural gas from the compressor package to a process discharge conduit of the natural gas system at the higher pressure. Emissions from the compressor package are captured in an emissions inlet conduit of an emissions management module (EMM) of a natural gas system. Captured emission are periodically circulated by a vapor recovery unit (VRU) of the EMM to the process suction conduit, a fuel gas system of the natural gas system, a hydrocarbon processing component that is separate from the compressor package, or a combination thereof.

In some embodiments, the EMM further comprises an emissions inlet conduit and a VRU control system, and the VRU comprises a circulator. The periodic circulation of the captured emissions from the VRU to the emissions discharge conduit is enabled by the VRU control system. The VRU control system activates the circulator to withdraw the captured emissions from the emissions inlet conduit when a pressure in the inlet conduit reaches an upper threshold value. The VRU control system circulates the withdrawn captured emissions from the emissions inlet conduit to the emissions discharge conduit, thereby reducing the pressure in the emissions inlet conduit. The VRU control system deactivates the circulator to terminate withdrawal of the captured emissions from the emissions inlet conduit when the pressure in the emissions inlet conduit reaches a lower threshold value. In further embodiment, the VRU control system deactivates the circulator if the pressure in the emissions inlet conduit does not reach the lower threshold within a preselected time period.

### High Pressure Emissions Sources

In some embodiments, the method comprises capturing emissions from a high pressure source in a natural gas system and periodically recycling the capture emissions to a component or system within the natural gas system. In some embodiments, the emissions inlet conduit fluidly connects the VRU to an emissions source having an initial pressure greater than the upper threshold value. In some embodiments, the ratio of the upper threshold value of pressure in the emissions inlet conduit to the pressure in the emissions discharge conduit (i.e., equivalent to operating pressure of the destination disposition) is less than or equal to 2, less than or equal to 1.8, or less than or equal to 1.5. In some embodiments where emissions are collected from one or more high pressure sources, the ratio of the upper threshold of the control range to the operating pressure of the destination disposition is greater than or equal to 1, greater than or equal to 1.1, or greater than or equal to 1.2. In some embodiments where emissions are collected from one or more high pressure sources, the ratio of the upper threshold of the control range to the operating pressure of the destination disposition is in a range of from 1 to 2, from 1.1 to 1.8, or from 1.2 to 1.5. When the ratio of the upper threshold value of pressure in the emissions inlet conduit to the pressure in the emissions discharge conduit is less than 1, flow from the high pressure disposition being cleared to the emissions discharge conduit would stop. Activation of the circulator induces flow from the high pressure disposition being cleared into the emissions discharge conduit when the pressure of high pressure disposition being cleared has been reduced to a pressure less than the pressure of the emissions discharge conduit. When the ratio of the upper threshold value of pressure in the emissions inlet conduit to the pressure in the emissions discharge conduit (i.e., equivalent to operating pressure of the destination disposition) is greater than 2, gas from the high pressure disposition being cleared to the emissions discharge conduit flows without the need for the circulator. The captured emissions flow from the emissions source to the emissions discharge conduit based on differential pressure until the pressure in the emissions inlet conduit reaches the upper threshold value.

In some embodiments, the captured emissions comprise emissions from an emissions source at a pressure greater than or equal to the pressure of the upper threshold of the control range. In some embodiments, the captured emissions comprise emissions from an emissions source at a pressure greater than or equal to 30 psia (207 kPaa), greater than or equal to 50 psia (345 kPaa), greater than or equal to 100 psia (689 kPaa), greater than or equal to 250 psia (1.7 MPaa), greater than or equal to 500 psia (3.4 MPaa). In some embodiments, the captured emissions comprise emissions from an emissions source at a pressure less than or equal to 1,000 psia (6.9 MPaa).

In some embodiments, the captured emissions comprise emissions related to shutdown of the compressor package, shutdown of a hydrocarbon processing component in the natural gas system other than the compressor package, or a combination thereof.

In some embodiments, the captured emissions comprise emissions from a blowdown system of the compressor package, a blowdown system of the natural gas system other than the blowdown system of the compressor package, or a combination thereof.

### Low Pressure Emissions Sources

In some embodiments, the method comprises capturing emissions from a low pressure source in a natural gas system and periodically recycling the capture emissions to a component or system within the natural gas system. In some embodiments, the emissions inlet conduit fluidly connects the VRU to an emissions source having an initial pressure less than the upper threshold value. In some embodiments, the upper threshold value is in a range of from twice the lower threshold value to less than the pressure in the emissions discharge conduit. The captured emissions accumulate in the emissions inlet conduit until the pressure in the emissions inlet conduit reaches the upper threshold value. In some embodiments, the inlet conduit further comprises a suction tank.

In some embodiments, the VRU is configured to maintain the emissions inlet conduit at a pressure less than or equal to 1 atmosphere.

In some embodiments, the captured emissions comprise emissions from an emissions source at a pressure less than or equal to the pressure of the upper threshold of the control range. In some embodiments, the captured emissions comprise emissions from an emissions source at a pressure less than or equal to 30 psia (207 kPaa). In some embodiments, the captured emissions comprise emissions from an emissions source at a pressure greater than or equal to 14.7 psia (101 kPaa).

In some embodiments, the captured emissions comprise emissions from the compressor package when in operation, a hydrocarbon processing component in the natural gas system in operation other than the compressor package, or a combination thereof.

In some embodiments, the captured emissions comprise emissions from a seal system of the compressor package, a vent system of the compressor package, a vent system of the natural gas system other than the vent system of the compressor package, or a combination thereof.

### Emissions Recycle

In some embodiments, the low-pressure emissions discharge conduit and/or the high-pressure emissions discharge conduit delivers the captured emissions to a hydrocarbon processing component in the natural gas system operating at a pressure less than or equal to the pressure of the upper threshold of the control range. In some embodiments, the hydrocarbon processing component in the natural gas system operating at a pressure less than or equal to 30 psia (207 kPaa). In some embodiments, the hydrocarbon processing component in the natural gas system operating at a pressure greater than or equal to 14.7 psia (101 kPaa).

In some embodiments, the emissions discharge conduit delivers the captured emissions to the process suction conduit, a fuel gas system of the natural gas system, a hydrocarbon processing component that is separate from the compressor package, or a combination thereof.

In some embodiments, the circulator comprises a compressor and a motor configured to drive the compressor. In some embodiments, the EMM comprises a support structure, and a power source supported on the support structure and configured to power the motor of the circulator. In some embodiments, the motor of the circulator is configured to receive electrical energy from an electrical power grid. In some embodiments, the compressor package comprises a cooling system comprising a fan and a driveshaft driven by the compressor and configured to rotate the fan. In some embodiments, the compressor package comprises an electrical power source comprising an electrical generator and a driveshaft driven by the compressor and configured to drive the electrical generator.

In some embodiments, the circulator comprises a gas ejector powered by a motive fluid flow. In some embodiments, the motive fluid flow comprises a flow of natural gas from the process discharge conduit.

### EMM Configurations

In some embodiments of the method, the EMM comprises a support structure on which the VRU is supported, and the support structure comprises a road transportable skid.

In some embodiments of the method, a plurality of the compressor packages arranged in parallel with respect to each other, and a plurality of the EMMs, wherein each of the EMMs is associated with one of the plurality of the compressor packages.

In some embodiments of the method, the VRU comprises a high-pressure circuit comprising a high-pressure gas circulator configured to receive a first stream of emissions from the compressor package and a low-pressure circuit comprising a low-pressure gas circulator configured to receive a second stream of emissions from the compressor package.

In some embodiments of the method, the high-pressure gas circulator comprises a high-pressure compressor or a high-pressure gas ejector, and the low-pressure gas circulator comprises a low-pressure compressor or a low-pressure gas ejector.

In some embodiments, one of the high-pressure gas circulator and the low-pressure gas circulator discharges into a fuel gas system of the compressor package, a fuel gas system of the natural gas system other than the fuel gas system of the compressor package, or a combination thereof.

In some embodiments of the method, the compressor package comprises a first compressor package of a plurality of compressor packages of the natural gas system, wherein the EMM is connected to the plurality of compressor packages in parallel whereby the emissions management module is configured to capture emissions from each of the plurality of compressor packages.

The following examples illustrate the invention; however, those skilled in the art will recognize numerous variations within the spirit of the invention and scope of the claims. To facilitate a better understanding of the present invention, the following examples of some embodiments are given. In no way should the following examples be read to limit, or to define, the scope of the invention.

### EXAMPLES

The following examples are included to demonstrate some embodiments of the invention. It should be appreciated by those of skill in the art that the techniques disclosed in the examples which follow represent techniques discovered by the inventor to function well in the practice of the invention, and thus can be considered to constitute enabling modes for its practice. However, those of skill in the art should, in light of the present disclosure, appreciate that many changes can be made in the specific embodiments which are disclosed and still obtain a like or similar result without departing from the spirit and scope of the invention.

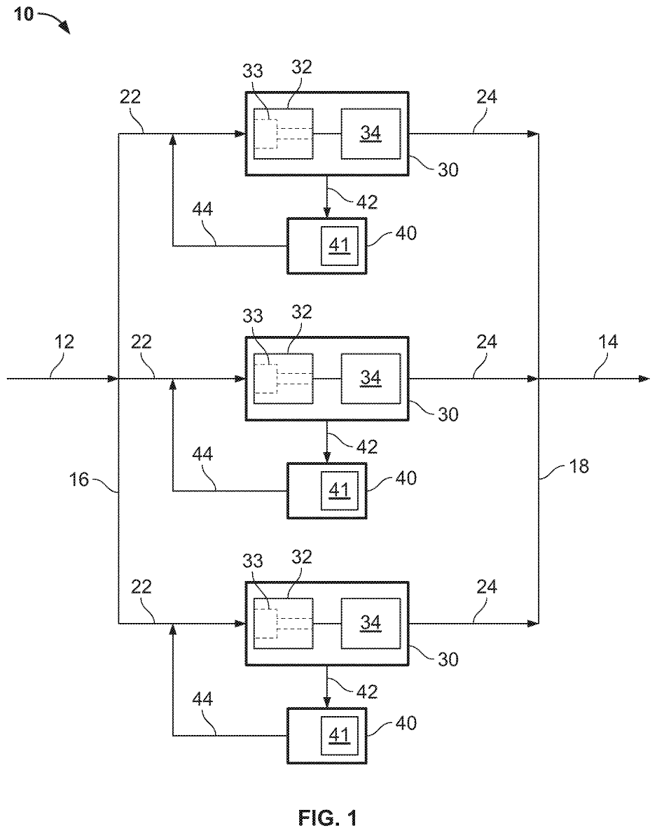

Referring now to FIG. 1, an embodiment of a natural gas system 10 is shown. In this exemplary embodiment, natural gas system 10 comprises a pipeline system for transporting natural gas from a production or other natural gas system to end-users and/or consumers of the natural gas transported by natural gas system 10. However, natural gas system 10 may also comprise other types of natural gas systems including, for example, a production system in which natural gas is produced from a wellbore extending through a subterranean earthen formation.

In this exemplary embodiment, natural gas system 10 generally includes a process first or upstream pipeline 12, a process second or downstream pipeline 14, a process inlet or suction header 16, a process second or discharge header 18, a plurality of compressor packages 30 each comprising a compressor 32, and a plurality of emissions management modules 40. Natural gas system 10 is represented schematically in FIG. 1 and may include features or components not illustrated in FIG. 1. Upstream pipeline 12 receives a flow of process gas (in the form of natural gas in this exemplary embodiment) from equipment connected thereto such as another pipeline, a wellhead, a compressor package, etc., and discharges the flow of natural gas to the suction header 16.

In this exemplary embodiment, the compressor 32 of each compressor package 30 receives a portion of the flow of natural gas supplied by upstream pipeline 12 via a process suction conduit 22 which extends from the suction header 16 to the compressor package 30, and discharges a flow of natural gas to the discharge header 18 via a process discharge conduit 24 extending from the compressor package 30 to the discharge header 18. Suction header 16 is connected to each of the suction conduits 22 while discharge header 18 is connected to each of the discharge conduits 24. The compressor packages 30 of natural gas system 10 compress the flow of natural gas received by upstream pipeline 12 (via the intervening suction header 16 and suction conduit 22) and discharges the flow of natural gas to downstream pipeline 14 connected thereto (via the intervening discharge conduit 24 and discharge header 18) which transports the flow of natural gas to equipment connected thereto such as, for example, another pipeline, another compressor package, etc., until the natural gas ultimately reaches the end-users and/or consumers of the natural gas.

Compressor packages 30 of natural gas system 10 may be disposed in parallel and thus may each receive a portion of the flow of natural gas received by upstream pipeline 12. Although natural gas system 10 is shown as including three compressor packages 30 in FIG. 1, the number of compressor packages 30 of natural gas system 10 may vary. Each compressor package 30 of natural gas system 10 generally includes a compressor 32 and a driver 34 which is mechanically connected with and drives the compressor 32. As used herein, the term “driver” is defined as a component configured to produce mechanical energy for mechanically driving a compressor. For example, the driver may produce mechanical energy in the form of rotational torque for rotating a crankshaft of a reciprocating compressor. Drivers may be powered by a variety of distinct energy sources. As one example, a driver may comprise a natural gas engine which combusts natural gas to produce rotational torque. As another example, a driver may comprise an electric motor which produces rotational torque from electrical energy supplied to the electric motor.

In this exemplary embodiment, compressor 32 comprises a reciprocating compressor including a reciprocating piston rod assembly 33; however, in other embodiments the configuration of compressor 32 may vary. Additionally, in this exemplary embodiment, driver 34 comprises an engine powered by natural gas and thus may also be referred to herein as natural gas engine 34. For example, driver 34 may be powered by the flow of natural gas received by the compressor package 30 from the upstream pipeline 12; however, in other embodiments, the configuration of driver 34 may vary. In some embodiments, driver 34 comprises a reciprocating internal combustion engine. In other embodiments, driver 34 may not comprise an engine and instead may comprise, for example, an electric motor and/or other component (a hydraulic drive, etc.) for producing mechanical energy to mechanically drive the compressor 32. Thus, driver 34 may also be referred to herein as electric motor 34.

Emissions management modules 40 of natural gas system 10 capture emissions produced from the compressor packages 30 to thereby reduce the amount of emissions, including greenhouse gases (primarily methane), communicated, directly or indirectly, to the atmosphere by compressor packages 30 during the operation of natural gas system 10. The emissions captured by emissions management modules 40 may comprise, for example, natural gas vented from controls of compressor packages 30 accidentally (e.g., via damage or failure) or by design (e.g., natural gas-actuated pneumatic controllers), emissions from the packing of piston rod assembly 33 (e.g., via damage or failure), emissions from a blowdown system of compressor packages 30 (accidentally or intentionally), and/or other sources of emissions of compressor packages 30. In this exemplary embodiment, emissions management modules 40 periodically recycle the captured emissions and return them to the process stream (i.e., the natural gas stream that is being processed/compressed by the compressor packages 30) upstream from the compressor packages 30 from which the emissions are captured such as, for example, to the suction header 16 and/or one or more of the suction conduits 22. In this manner, the emissions captured by emissions management modules 40 may be recycled back into the flow of natural gas and ultimately discharged to the discharge pipeline 14 once compressed by compressor packages 30. It may be understood that in other embodiments the captured emissions may be consumed as fuel gas by one or more components of the natural gas system 10.

In this exemplary embodiment, each emissions management module 40 is connected to a corresponding compressor package 30. Particularly, each emissions management module 40 is connected to a corresponding compressor package 30 by one or more emissions inlet conduits 42 extending from the compressor package 30 to the emissions management module 40. Additionally, an emissions discharge conduit 44 extends from the emissions management module 40 to the suction conduit 22 extending to the compressor package 30 associated with the given emissions management module 40. In this configuration, the emissions management module 40 captures emissions (primarily methane) from the corresponding compressor package 30 via emissions inlet conduit 42, and returns or recycles the emissions to the suction conduit 22 via emissions discharge conduit 44. In this configuration, a continuous loop is formed which includes suction conduit 22, compressor package 30, emissions inlet conduit 42, emissions management module 40, and emissions discharge conduit 44. In other embodiments, emissions discharge conduit 44 may extend to the suction header 16 rather than the suction conduit 22 and/or to some other natural gas conduit located upstream from the compressor package 30.

Additionally, each emissions management module 40 includes equipment to process or condition the emissions captured from the corresponding compressor package 30 prior to returning the captured emissions to the suction conduit 22 positioned upstream from the compressor package 30. In this exemplary embodiment, each emissions management module 40 comprises a VRU 41 including a gas circulator for periodically driving the circulation of the emissions captured from the corresponding compressor package 30 such that the emissions may be periodically circulated to the suction conduit 22. As used herein, the term “gas circulator” is defined as referring to any device configured for periodically driving or powering the circulation of gas from a first location to a second location. The gas circulators described herein may have one or more moving (e.g., rotating) parts driven by a power source. Alternatively, gas circulators disclosed herein may not include any moving parts and instead may be driven by a motive fluid. For example, the gas circulator of VRU 41 may comprise a compressor, an ejector or eductor, and/or other devices known in the art for circulating a gas stream. The VRU 41 may be powered by a power supply of the emissions management module 40 (e.g., a generator, a solar panel or array) or via an external source of power such as power supplied by the associated compressor package 30, another external source of power such as an electric grid, or motive natural gas downstream of natural gas system 10.

Emissions management modules 40 provide a means for capturing emissions produced by compressor packages 30 while minimizing the additional infrastructure which must be added to natural gas system 10. For example, an additional tank battery or flare need not be connected to emissions management modules 40 given that emissions management modules 40 conveniently periodically recycle the captured emissions to the suction conduits 22 of natural gas system 10 where the emissions may be processed and discharged by compressor packages 30 to the downstream pipeline 14, thereby preserving the captured emissions for downstream processing and sale rather than having the captured emissions potentially communicated to the atmosphere. Indeed, emissions management modules 40 may conveniently be added to a pre-existing natural gas system with minimal modification to the natural gas system needed to interface the emissions management modules 40 with the natural gas system. Additionally, emissions management modules 40 do not feed the captured emissions directly to the driver 34 (downstream from any fuel gas conditioning equipment of the driver 34 such as a fuel filter or pressure regulator of driver 34) of the associated compressor package 30, avoiding the undesirable effects (e.g., decline in reliability and/or performance of driver 34) associated with routing emissions directly to the driver 34 as a fuel source for the driver 34.

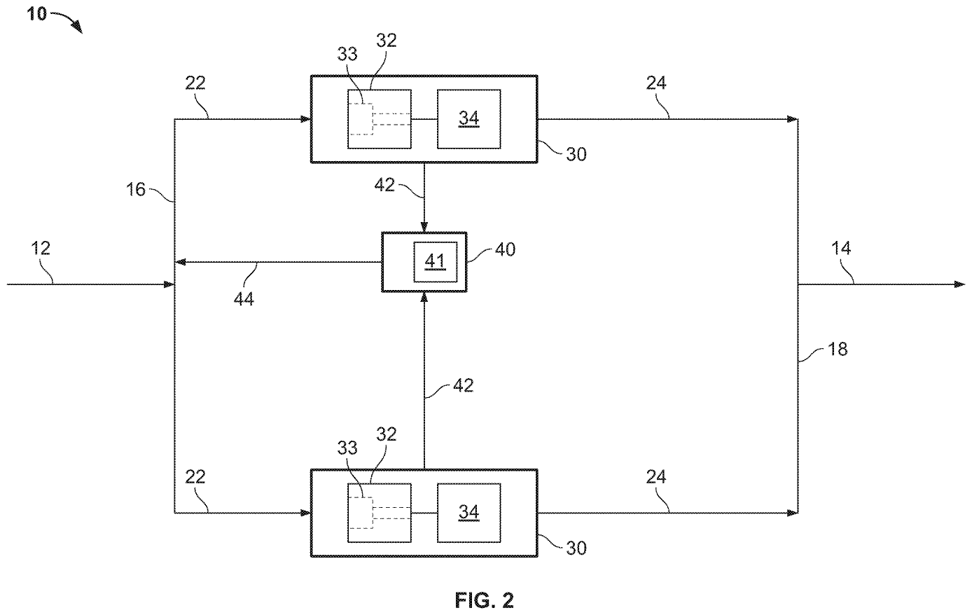

Referring briefly to FIG. 2, another embodiment of a natural gas system 10 is shown. Natural gas system 10 includes upstream pipeline 12, downstream pipeline 14, discharge header 18, process suction conduit 22, process discharge conduit 24, compressor 32, piston rod assembly 33, driver 34, emissions management module 40, VRU 41, and emissions inlet conduit 42. In this exemplary embodiment, natural gas system 10 includes an emissions management module 40 which captures emissions from a plurality of separate compressor packages 30. Additionally, in this exemplary embodiment, emissions discharge conduit 44 extends from emissions management module 40 to the suction header 16. Thus, emissions captured by emissions management module 40 are periodically recirculated to each of the compressor packages 30 of natural gas system 10. While in this exemplary embodiment emissions management module 40 captures emissions from a pair of compressor packages 30, in other embodiments a single emissions management module 40 may capture emissions from more than two separate compressor packages 30. The ratio of compressor packages 30 to emissions management modules 40 may vary depending the requirements of the particular application.

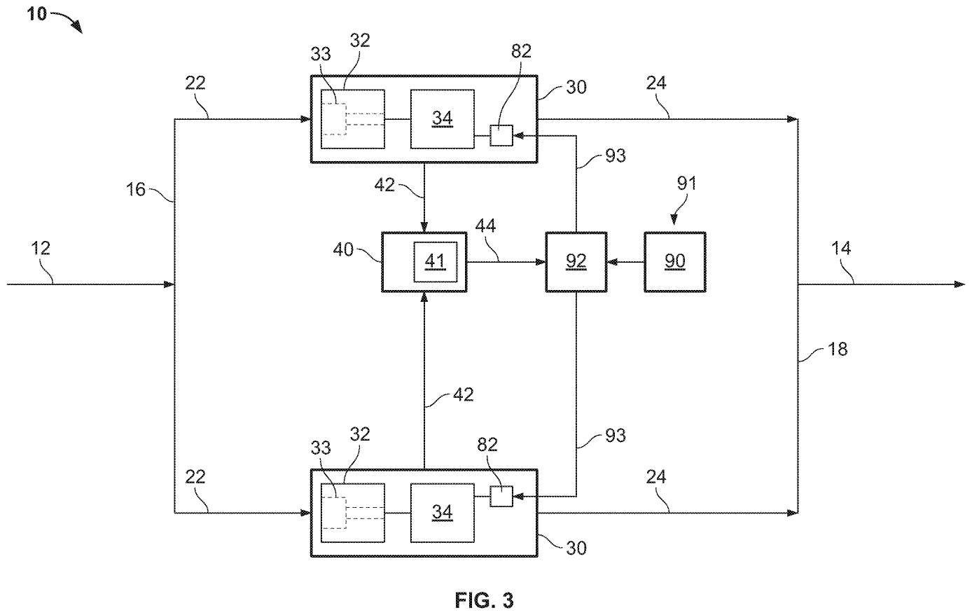

Referring to FIG. 3, another embodiment of a natural gas system 10 is shown. Natural gas system 10 includes downstream pipeline 14, discharge header 18, piston rod assembly 33, emissions management module 40. In this exemplary embodiment, natural gas system 10 includes a pair of compressor packages 30 and an emissions management module 40 which captures emissions from the pair of compressor packages 30.

Particularly, each compressor package comprises a fuel gas conditioner 82 configured to filter or condition fuel gas supplied to the driver 34 of the compressor package 30 (the driver 34 being in fluid communication with the fuel gas conditioner 82) by a fuel source 90 of the natural gas system 10. Fuel gas conditioner 82 comprises equipment for conditioning the fuel gas before it is consumed by the driver 34. In some embodiments, fuel gas conditioner 82 comprises a fuel filter, a liquid separator, and/or one or more pressure regulators. In this exemplary embodiment, natural gas system 10 additionally includes a fuel header or manifold 92 positioned between the fuel source 90 and the pair of compressor packages 30, the fuel header 92 serving to distribute fuel gas from the fuel source 90 to the pair of compressor packages 30. Particularly, in this exemplary embodiment, a pair of fuel gas conduits 93 extend from the fuel header 92 to the fuel filters 82 of the pair of compressor packages 30, thereby connecting the fuel header 92 with the compressor packages 30. In this configuration, the fuel filters 82 of compressor packages 30 are located downstream from the fuel header 92, which is similarly located downstream from the fuel source 90. In some embodiments, fuel source 90 may comprise natural gas diverted from the upstream pipeline 12 and/or suction conduits 22 of the natural gas system 10. Thus, the fuel source 90 may comprise a suction-side component (e.g., upstream pipeline 12 and/or suction conduits 22) of natural gas system 10. In other embodiments, fuel may be sourced from a compressor discharge, interstage compression, or a non-compression gas source of the natural gas system 10.

In this exemplary embodiment, emissions management module 40 receives emissions captured from compressor packages 30 via emissions inlet conduits 42, and periodically return the captured emissions to a fuel system 91 of the natural gas system 10 including the fuel source 90, fuel header 92, and fuel gas conduits 93. Particularly, emissions management module 40 periodically returns at least a portion of the captured emissions to the fuel header 92, upstream from the fuel filters 82 of the compressor packages 30. The captured emissions, after being filtered or otherwise conditioned by fuel filters 82 may be consumed by drivers 34 of compressor packages 30 to assist in powering the drivers 34. In some instances, providing the captured emissions to the drivers 34 as fuel may maximize the efficiency of the natural gas system 10 by reducing the amount of captured emissions which are directed to compressor packages 30 to be compressed by the compressors 32 of packages 30.

As will be discussed further herein, the VRU 41 of emissions management module 40 may apply a motive force or pressure (positive or negative pressure) to the captured emissions permitting the captured emissions to be periodically communicated from the module 40 to the fuel header 92 thereof without reliance on drivers 34 themselves to provide said motive force. This permits the captured emissions to be routed upstream of the fuel filters 82 of compressor packages 30 such that the captured emissions may be properly filtered or otherwise conditioned before being supplied to drivers 34. In this manner, the captured emissions directed to the fuel system 91 by emissions management module 40 appears as just another fuel source (in addition to fuel source 90) to the fuel header 92, limiting or preventing any undesirable impacts to the operation of drivers 34 through the inclusion of the captured emissions in the fuel sources thereof, while also minimizing the amount of work required to incorporate the emissions management module 40 into a preexisting natural gas system (e.g., the natural gas system 10 shown in FIG. 3). Particularly, an emissions discharge conduit 44 of the emissions management module 40 may merely be connected between the emissions management module 40 and the fuel header 92. The connection formed between emissions discharge conduit 44 and fuel header 92 may be like any other connection formed between fuel header 92 and other components of fuel system 91, such as the connection formed between fuel source 90 and fuel header 92.

While in this exemplary embodiment the fuel system 91 of natural gas system 10 includes fuel source 90, fuel header 92, and fuel gas conduits 93, it may be understood that in other embodiments fuel system 91 may not include fuel header 92 with emissions discharge conduit 44 being connected to fuel system 91 at another location also located upstream from the fuel filters 82 (e.g., connected to the fuel gas conduits 93) of compressor packages 30 similarly permitting the captured emissions to be filtered or otherwise conditioned by fuel filters 82 before being supplied to drivers 34. It may similarly be understood that fuel system 91 may include additional components not shown in FIG. 3.

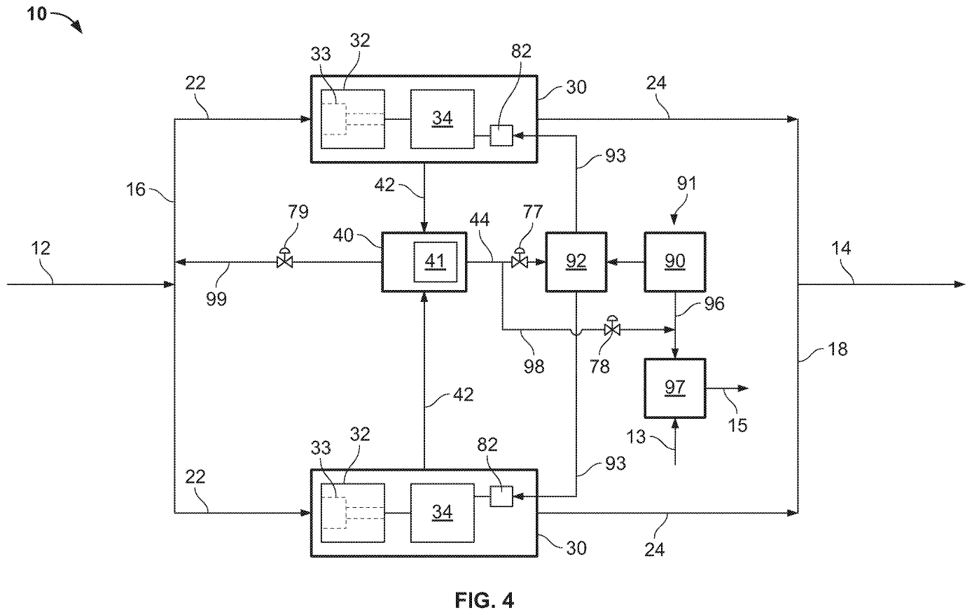

Referring to FIG. 4, another embodiment of a natural gas system 10 is shown. Natural gas system 10 includes downstream pipeline 14, discharge header 18, process suction conduit 22, compressor 32, piston rod assembly 33, driver 34, emissions management module 40, and emissions inlet conduit 42. Natural gas system 10 includes the pair of compressor packages 30 and the emissions management module 40 described above. Additionally, in this exemplary embodiment, natural gas system 10 includes a hydrocarbon processing component 97 coupled to the emissions management module 40.

The hydrocarbon processing component 97 of natural gas system 10 may comprise various types of equipment used in the processing and production of process gas (e.g., natural gas) accomplished by the natural gas system 10. Hydrocarbon processing component 97 may not otherwise be directly connected or otherwise directly associated with either of the compressor packages 30 and instead may relate to an unrelated subsystem of the natural gas system 10. As an example, hydrocarbon processing component 97 may comprise a pressure vessel such as a boiler, a furnace, a compressor package, a heat exchanger, etc. Indeed, compressor packages 30 comprise hydrocarbon processing components and may also be referred to herein as such.

Hydrocarbon processing component 97 receives an inlet process gas stream 13 of the natural gas system 10, processes the natural gas received from the inlet process stream 13, and discharges a discharge process gas stream 15 which is supplied or distributed to other equipment of natural gas system 10. The natural gas comprising the inlet process gas stream 13 and/or the natural gas comprising discharge process gas stream 15 may be similar in composition to the natural gas flowing through upstream pipeline 12. Additionally, the hydrocarbon processing component 97 receives fuel gas from a fuel gas conduit 96 extending to the hydrocarbon processing component 97 from the fuel source 90 of fuel gas system 91. The fuel gas supplied to the hydrocarbon processing component 97 via fuel gas conduit 96 is consumed by the component 97 as part of processing the inlet process gas stream 13 received by the hydrocarbon processing component 97. For example, the fuel gas supplied to hydrocarbon processing component 97 may be burned in a burner assembly of the hydrocarbon processing component 97 to heat the inlet process gas stream 13 to assist in separating as desired one fraction of the inlet process gas stream 13 from another fraction of the inlet process gas stream 13.

In this exemplary embodiment, in addition to being configured to discharge emissions captured from compressor packages 30 to the fuel header 92 via the emissions discharge conduit 44, emissions management module 40 is also configured to periodically discharge captured emissions to the hydrocarbon processing component 97 via a branch emissions discharge conduit 98, and to the suction header 16 via a supplemental emissions discharge conduit 99. Particularly, in this exemplary embodiment, branch emissions discharge conduit 98 extends from the emissions discharge conduit 44 to the fuel gas conduit 96 extending to the hydrocarbon processing component 97. Alternatively, branch emissions discharge conduit 98 may extend directly between emissions management module 40 and the fuel gas conduit 96. Additionally, in this exemplary embodiment, the supplemental emissions discharge conduit 99 extends from the emissions management module 40 to the suction header 16. Alternatively, supplemental emissions discharge conduit 99 may extend from the emissions discharge conduit 44 to the suction header 16.

In this exemplary embodiment, captured emissions may be circulated from the VRU 41 of emissions management module 40 to the fuel filters 82 of compressor packages 30, the hydrocarbon processing component 97, and/or to the suction header 16. In this exemplary embodiment, valves 77, 78, and 79 are positioned along each of conduits 44, 98, and 99, respectively, whereby conduits 44, 98, and 99 may be selectably isolated as desired by an operator of natural gas system 10.

As an example, a valve 79 positioned along the supplemental emissions discharge conduit 99 may be closed whereby emissions captured from compressor packages 30 are directed from the emissions management module 40 to the fuel header 92 and hydrocarbon processing component 97 (as fuel gas delivered to component 97 via the fuel gas conduit 96) but not to the suction header 16. Alternatively, a valve 78 positioned along branch emissions discharge conduit 98 may be closed whereby captured emissions are periodically directed from the emissions management module 40 to the fuel header 92 and suction header 16 but not to the hydrocarbon processing component 97. As an additional alternative, a valve 77 positioned along emissions discharge conduit 44 may be closed whereby captured emissions are periodically directed from the emissions management module 40 to the hydrocarbon processing component 97 and suction header 16 but not to the fuel header 92. As an additional alternative, multiple valves 77, 78, and 79 may be closed at a given time such that captured emissions are directed from the emissions management module 40 to only one of the suction header 16, fuel header 92, and hydrocarbon processing component 97. As a further alternative, each of the valves 77, 78, and 79 may be open whereby captured emissions are periodically directed from the emissions management module 40 concurrently to the suction header 16, fuel header 92, and hydrocarbon processing component 97. The selection of which valves 77, 78, and 79 to close and which of valves 77, 78, and 79 to remain open may be based on the current needs of the natural gas system 10, such as, among other reasons, the current volume of captured emissions being discharged from the emissions management module 40.

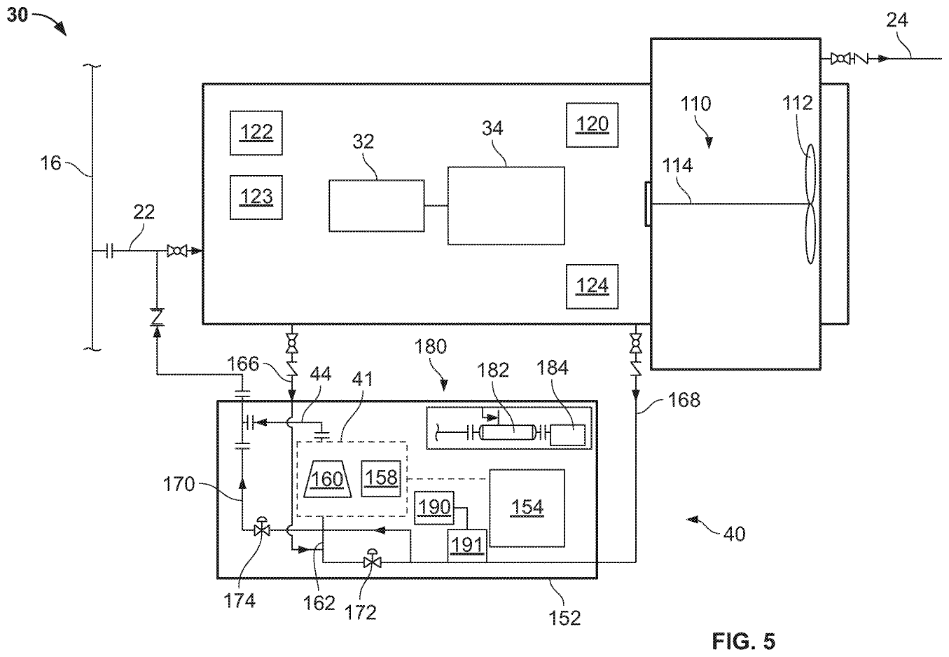

Referring now to FIG. 5, an embodiment of a compressor package 30 and an emissions management module 40 of a natural gas system are shown in greater detail. Natural gas system 10 includes upstream pipeline 12, downstream pipeline 14, discharge header 18, process discharge conduit 24, compressor 32, piston rod assembly 33, driver 34, emissions management module 40, VRU 41, and emissions inlet conduit 42. In this exemplary embodiment, compressor package 30 generally includes a driver 34 and a reciprocating compressor 32 driven by the driver 34. The compressor package 30 shown in FIG. 5 may comprise one or more of the compressor packages 30 while the emissions management module 40 shown in FIG. 5 may comprise one or more of the emissions management modules 40. In this exemplary embodiment, compressor package 30 generally includes a driver 34 and a reciprocating compressor 32 driven by the driver 34. In this exemplary embodiment, driver 34 comprises a natural gas engine; however, in other embodiments, the configuration of driver 34 may vary. For example, in other embodiments, driver 34 may comprise an electric motor. Additionally, compressor package 30 includes a cooling system 110 for cooling components of the compressor package 30 including driver 34 and/or compressor 32. In this exemplary embodiment, cooling system 110 includes, among other features, a cooling fan 112 driven by a driveshaft 114. Driveshaft 114 of cooling system 110 may be driven by the driver 34 of compressor package 30.

In this exemplary embodiment, emissions management module 40 generally includes a support structure 152, an onboard power source 154, a VRU 41, an air system 180, and a control panel or system (illustrated schematically by box 190 in FIG. 5) for controlling the operation of at least some components of emissions management module 40. In this exemplary embodiment, support structure 152 may comprise a skid upon which the components of emissions management module 40 (e.g., onboard power source 154, VRU 41, air system 180, etc.) are positioned. However, in other embodiments, the configuration of support structure 152 may vary. For instance, in some embodiments, support structure 152 may comprise a road-transportable trailer. The onboard power source 154 provides power to components of emissions management module 40 including, for example, VRU 41. In this exemplary embodiment, onboard power source 154 comprises an electrical generator powered by the flow of natural gas provided by suction header 16 of natural gas system 10. However, in other embodiments, the configuration of onboard power source 154 may vary. Additionally, in this exemplary embodiment, onboard power source 154 provides 460 volt (V) three-phase electrical power to the components of emissions management module 40; however, it may be understood that the type and magnitude of power outputted by onboard power source 154 may vary depending on the given application.

The VRU 41 of emissions management module 40 processes emissions captured by emissions management module 40 from compressor package 30 prior to periodically returning the captured emissions to natural gas system 10 at a location upstream from compressor package 30. VRU 41 of emissions management module 40 generally includes a gas circulator motor 158 and a gas circulator 160 driven by the gas circulator motor 158. In this exemplary embodiment, gas circulator 160 comprises a compressor and thus may also be referred to herein as gas circulator compressor 160. Additionally, in this exemplary embodiment, gas circulator motor 158 comprises an electric motor powered by the onboard power source 154 of emissions management module 40; however, in other embodiments, the configuration of gas circulator motor 158 may vary. For example, in other embodiments, gas circulator motor 158 may comprise a natural gas motor powered by the flow of natural gas provided by suction header 16. Gas circulator compressor 160 is mechanically driven by gas circulator motor 158 and may comprise a rotary compressor which may include a screw, scroll, rotary vane or other types of rotors. In other embodiments, gas circulator compressor 160 may comprise a reciprocating compressor. As will be discussed further herein, gas circulator compressor 160 compresses emissions received by the VRU 41 prior to returning the emissions to the suction of compressor package 30. Particularly, in this exemplary embodiment, VRU 41, and particularly gas circulator compressor 160, receive emissions via an emissions suction conduit 162 and discharge pressurized emissions via an emissions discharge conduit 44 of emissions management module 40.

The air system 180 of emissions management module 40 provides compressed or pressurized air to power features of compressor package 30 via one or more conduits (not shown in FIG. 5) extending between emissions management module 40 and compressor package 30. The compressed air provided by air system 180 may replace the natural gas used to power at least some of the pneumatically powered instrumentation and/or controls (illustrated schematically by box 120 in FIG. 5) of compressor package 30 such as, for example, louvers of cooling system 110, liquid level controllers, pre-lube motors, the starter motor, etc., of compressor package 30. The amount of greenhouse gases produced by compressor package 30 during operation may be reduced by substituting natural gas with air for powering at least some of the instrumentation and/or controls 120 of compressor package 30 via the air system 180 of emissions management module 40. Additionally, by housing air system 180 on the emissions management module 40, the amount of additional infrastructure to be provided by compressor package 30 (e.g., an air compressor, etc.) may be minimized.

In this exemplary embodiment, air system 180 generally includes an air receiver 182 and an air compressor 184. Air compressor 184 may be powered by onboard power source 154 of emissions management module 40; however, the configuration and manner of powering air compressor 184 may vary in other embodiments. In still other embodiments, emissions management module 40 may not include air system 180. In some embodiments, air system 180 may also include an air dryer to reduce moisture in the air after it is compressed by air compressor 184.

Emissions management module 40 may capture emissions from compressor package 30 from various sources of compressor package 30. For example, in this exemplary embodiment, a first emissions inlet conduit 166 and a second emissions inlet conduit 168 each extend from compressor package 30 to the suction conduit 162 of emissions management module 40. In other embodiments, the number of emissions conduits extending from compressor package 30 to the suction conduit 162 of emissions management module 40 may vary from that shown in FIG. 5. In this exemplary embodiment, first emissions inlet conduit 166 may receive emissions vented from a variety of sources from compressor package 30. For example, the emissions received by first emissions inlet conduit 166 may include vented natural gas from a seal system (indicated schematically by box 122 in FIG. 5), and/or vent system (indicated schematically by box 123 in FIG. 5) of the compressor package 30. The seal system 122 of compressor package 30 comprises various seals of the compressor package 30 used to seal various corresponding interfaces of the compressor package 30 and which may inadvertently emit emissions over time as the performance of the given seal degrades. For example, seal system 122 may include piston rod packing seals which seal the piston rod assembly 33 of compressor package 30, variable volume pocket seals, and others. The vent system 123 of compressor package 30 comprises various vents of the compressor package 30 used to vent, by design, various emissions for various purposes. For example, the vent system 123 may include vented emissions originating from instrumentations and/or controls 120 of compressor package 30. Vent system 123 may also include emissions vented by so called “breathers” of the compressor package 30 such as, for example, a compressor frame breather or an engine crankcase breather of the compressor package 30.

The emissions received by first emissions inlet conduit 166 may include sources of emissions produced by compressor package 30 other than those originating from seal system 122 and vent system 123. For example, the emissions received by first emissions inlet conduit 166 may also include exhaust gas from a starter motor used to start the driver 34 of compressor package 30, and a pre-lube motor associated with a lubrication system of compressor package 30.

Second emissions inlet conduit 168 is configured to receive emissions from a blowdown system (indicated by box 124 in FIG. 5) used to vent natural gas from compressor package 30 when package 30 is shut down for maintenance or other purposes. In some applications, the blowdown emissions vented to second emissions inlet conduit 168 may be at a relatively high-pressure which cannot be directly fed to the VRU 41 of emissions management module 40. Thus, in this exemplary embodiment, emissions management module 40 includes a blowdown bypass conduit 170 extending from the second emissions inlet conduit 168 to the discharge conduit 44. Additionally, a first or low-pressure (LP) blowdown valve 172 is positioned along second emissions inlet conduit 168 between the suction conduit 162 and the location at which blowdown bypass conduit 170 connects with second emissions inlet conduit 168. Further, a second or high-pressure (HP) blowdown valve 174 is positioned along blowdown bypass conduit 170. In some embodiments, the operation of blowdown valves 172, 174 may be controlled by control panel 190 powered by a power source 191. Power source 191 may be located on and/or off support structure 152 and may comprise batteries, a solar panel or array to charge one or more batteries, and/or other power sources.

Upon shutting down compressor package 30, LP blowdown valve 172 may be in a closed position while HP blowdown valve 174 is an open position, permitting pressurized blowdown emissions within second emissions inlet conduit 168 to bypass VRU 41 and flow into the suction conduit 22 via discharge conduit 44. The additional volume provided by suction header 16 and suction conduit 22 allows for the pressure within blowdown system 124 and second emissions inlet conduit 168 to bleed down to a desired reduced pressure equal to the fluid pressure within suction header 16. Once pressure within blowdown system 124 and second emissions inlet conduit 168 have bled down to the reduced pressure, HP blowdown valve 174 may be closed to force the blowdown emissions to flow through VRU 41 for processing rather than bypassing VRU 41 via blowdown bypass conduit 170. In this manner, high-pressure emissions from blowdown system 124 may be processed by the same VRU 41 used to process low-pressure emissions from either of the seal system 122 or vent system 123 of compressor package 30, eliminating the need for separate VRUs 41 and/or separate emissions management modules 40 to service the same compressor package 30.

It may be understood that the configuration of emissions management module 40 (e.g., the configuration, placement, and/or arrangement of VRU 41, conduits 162, 44, valves 172, 174, etc.) shown in FIG. 5 is only exemplary and in other embodiments the configuration of emissions management module 40 may vary. For example, in other embodiments, emissions management module 40 may include components not shown in FIG. 5 and/or may not include at least some of the features shown in FIG. 5.

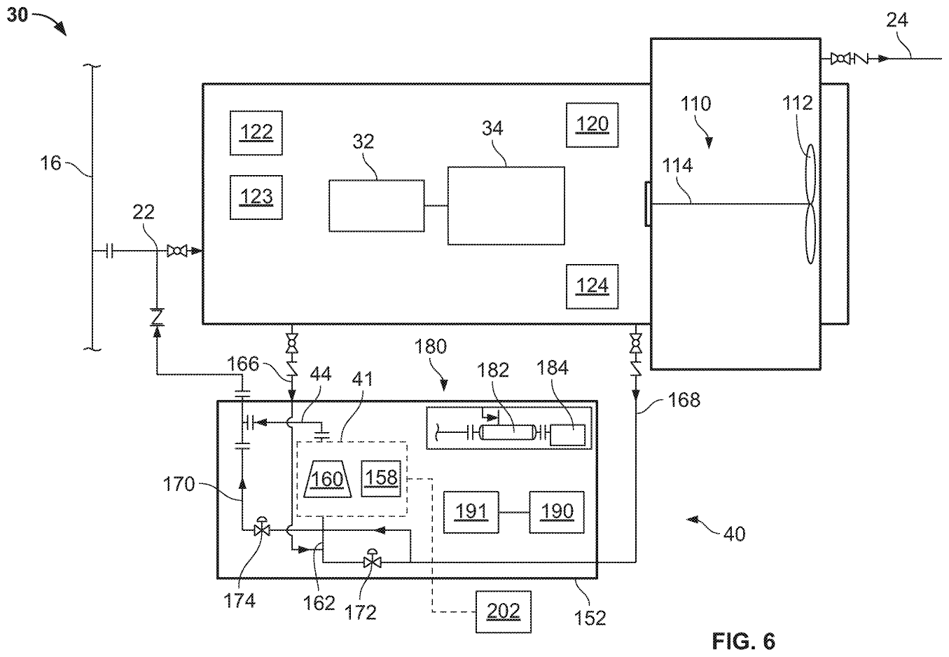

Referring now to FIG. 6, another embodiment of an emissions management module 40 of a natural gas system is shown. The emissions management module 40 shown in FIG. 6 may comprise one or more of the emissions management modules 40. Natural gas system 10 includes upstream pipeline 12, downstream pipeline 14, discharge header 18, process discharge conduit 24, compressor 32, piston rod assembly 33, driver 34, emissions management module 40, VRU 41, and emissions inlet conduit 42. In this exemplary embodiment, compressor package 30 generally includes a driver 34 and a reciprocating compressor 32 driven by the driver 34. Emissions management module 40 includes features in common with emissions management module 40 shown in FIG. 5, and shared features are labeled similarly.

Particularly, emissions management module 40 does not include the onboard power source 154 of emissions management module 40. Instead, emissions management module 40 is powered by an external power source (indicated schematically by box 202 in FIG. 6) not located on the support structure 152 thereof. External power source 202 may be provided by the natural gas system 10 and thus may power other components of system 10. For example, external power source 202 may comprise an electrical power grid to which the emissions management module 40 is electrically connected. Such a configuration may be advantageous for eliminating the emissions produced by power source 154 in applications where such external electrical power is available. Alternatively, external power source 202 may comprise an offboard electrical generator or other power system for providing power to the emissions management module 40. The power received by emissions management module 40 from external power source may be 460V three-phase electrical power; however, the power supplied to emissions management module 40 by external power source 202 may vary depending on the given application.

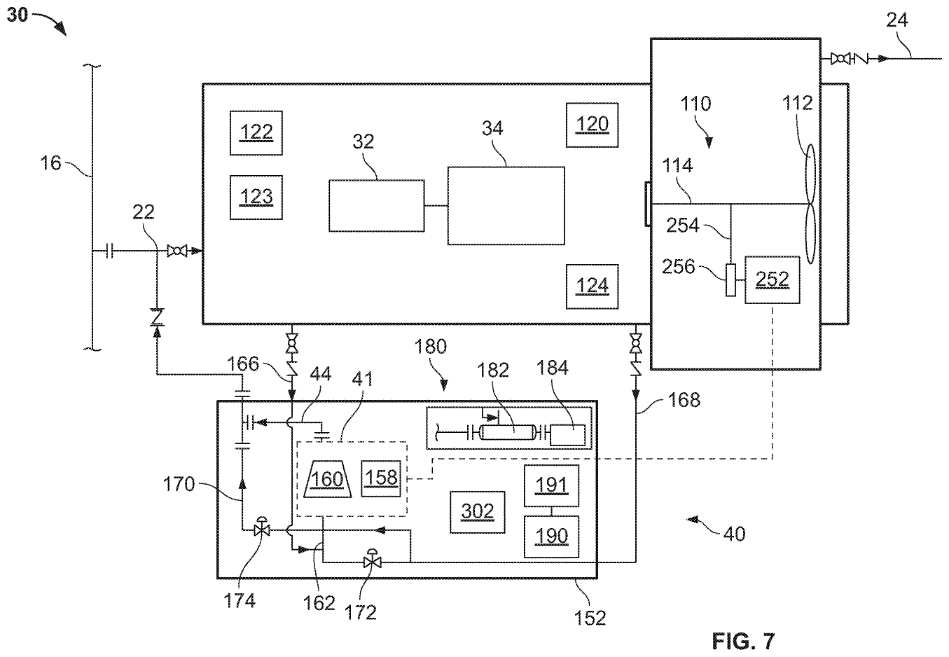

Referring now to FIG. 7, another embodiment of a compressor package 30 and an emissions management module 40 of a natural gas system are shown in greater detail. The compressor package 30 shown in FIG. 7 may comprise one or more of the compressor packages 30 while the emissions management module 40 shown in FIG. 7 may comprise one or more of the emissions management modules 40. Natural gas system 10 includes upstream pipeline 12, downstream pipeline 14, discharge header 18, process suction conduit 22, process discharge conduit 24, compressor 32, piston rod assembly 33, driver 34, emissions management module 40, VRU 41, and emissions inlet conduit 42. In this exemplary embodiment, compressor package 30 generally includes a driver 34 and a reciprocating compressor 32 driven by the driver 34. Compressor package 30 and emissions management module 40 includes features in common with compressor package 30 and emissions management module 40, respectively, shown in FIG. 5, and shared features are labeled similarly.

Particularly, in this exemplary embodiment, compressor package 30 includes an electrical generator 252 coupled to the driveshaft 114 of cooling system 110 by a mechanical linkage 254. Linkage 254 may comprise belt(s), chain(s), gear train(s), and/or other mechanisms for transferring mechanical energy from driveshaft 114 to an input or drive gear 256 of electrical generator 252. In this configuration, rotation of the driveshaft 114 of cooling system 110 (driven by the operation of driver 34 of compressor package 30) rotates the drive gear 256 of generator 252, causing generator 252 to output electrical power. Generator 252 is electrically connected to the emissions management module 40 (which does not include onboard power source 154) whereby generator 252 may power the emissions management module 40, including the VRU 41 and/or air system 180 thereof. The power received by emissions management module 40 from generator 252 may be 460V three-phase electrical power; however, the power supplied to emissions management module 40 by generator 252 may vary depending on the given application. In this manner, the emissions provided by the onboard power source 154 of emissions management module 40 may be eliminated while also not relying on external power (e.g., an electrical power grid) which may be unavailable in at least some applications. Additionally, in this exemplary embodiment, emissions management module comprises a battery system 302 chargeable by electrical generator 252. Battery system 302 may power emissions management module 40 when the associated compressor package 30 is shut-down.

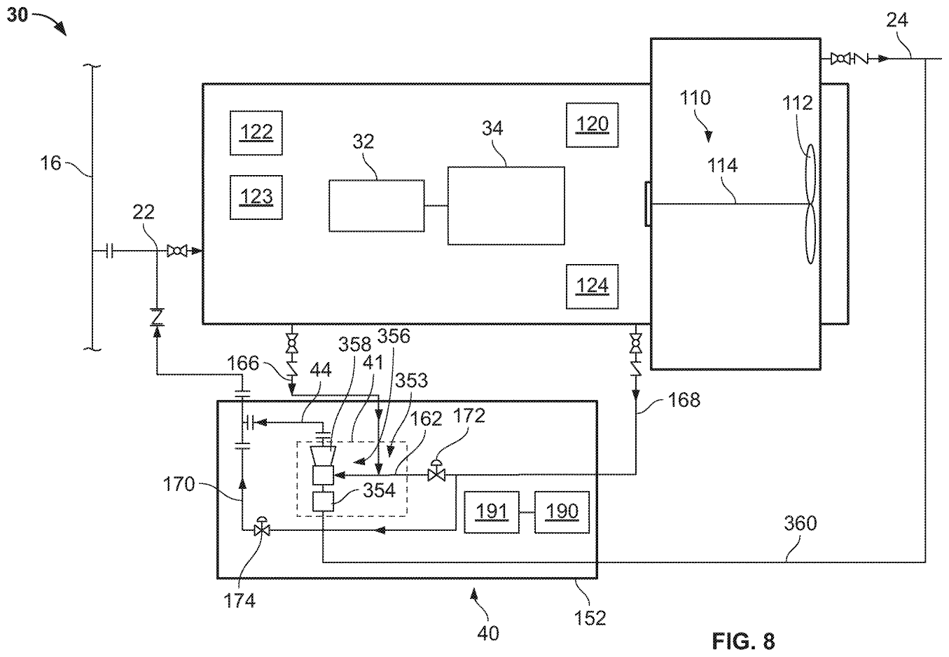

Referring now to FIG. 8, another embodiment of an emissions management module 40 of a natural gas system is shown. The emissions management module 40 shown in FIG. 8 may comprise one or more of the emissions management modules 40. Natural gas system 10 includes upstream pipeline 12, downstream pipeline 14, discharge header 18, process suction conduit 22, process discharge conduit 24, compressor 32, piston rod assembly 33, driver 34, emissions management module 40, VRU 41, and emissions inlet conduit 42 as shown in natural gas system 10 shown in FIG. 1. In this exemplary embodiment, compressor package 30 generally includes a driver 34 and a reciprocating compressor 32 driven by the driver 34. Emissions management module 40 includes features in common with emissions management module 40 shown in FIG. 5, and shared features are labeled similarly. Particularly, rather than an electrically powered VRU such as the VRU 41 of emissions management module 40 shown in FIG. 5, emissions management module 40 includes a natural gas powered VRU 41 which does not rely on an electrical power source such as power source 154 for operation.

Instead, in this exemplary embodiment, VRU 41 comprises a gas circulator 353 including a suction tank or vessel 354 and a fluid powered gas ejector 356 configured to compress emissions captured from compressor package 30 to a process suction (e.g., suction conduit 22) of the compressor package 30. Particularly, gas ejector 356 of gas circulator 353 includes a nozzle-diffuser assembly 358 which receives both captured emissions from suction tank 354 and a motive fluid from discharge conduit 24 via a motive fluid conduit 360 extending between discharge conduit 24 and gas ejector 356. Gas ejector 356 may also be referred to as a venturi jet, a jet mixer, an aspirator, and a gas eductor. In other embodiments, the motive fluid provided to gas ejector 356 may be sourced from locations in addition to or other than discharge conduit 24. For example, the motive fluid supplied to gas ejector 356 may be provided from a downstream pipeline (e.g., downstream pipeline 14 shown in FIG. 1 and FIG. 2), a discharge of the natural gas system or facility in which emissions management module 40 is located, and/or from some other source or location.

In this exemplary embodiment, the nozzle-diffuser assembly 358 includes an upstream nozzle, a downstream diffuser, and a throat positioned between the nozzle and diffuser. In this configuration, the high-pressure natural gas provided to ejector 356 by discharge conduit 24 powers the compression of the captured emissions through nozzle-diffuser assembly 358 of gas ejector 356 and into the suction conduit 22. Thus, by powering ejector 356 by the high-pressure natural gas discharged by compressor package 30, VRU 41 need not employ a powered rotary or reciprocating compressor for periodically driving the compression of captured emissions through emissions management module 40. This avoids the requirement of supplying emissions management module 40 with a potentially emissions-producing high voltage electrical power source (e.g., a power source providing 400+ V). Instead, only the low-voltage control panel 190 may need be electrically powered in this exemplary embodiment, where the limited power requirements of control panel 190 may be satisfied by batteries of compressor package 30. However, in other embodiments, the emissions management module 40 may include both gas ejector 356 and a rotary or reciprocating compressor. Additionally, in some embodiments, emissions management module 40 may include a plurality of gas ejectors 356 or a combination of a rotary or reciprocating compressor and a plurality of gas ejectors 356.

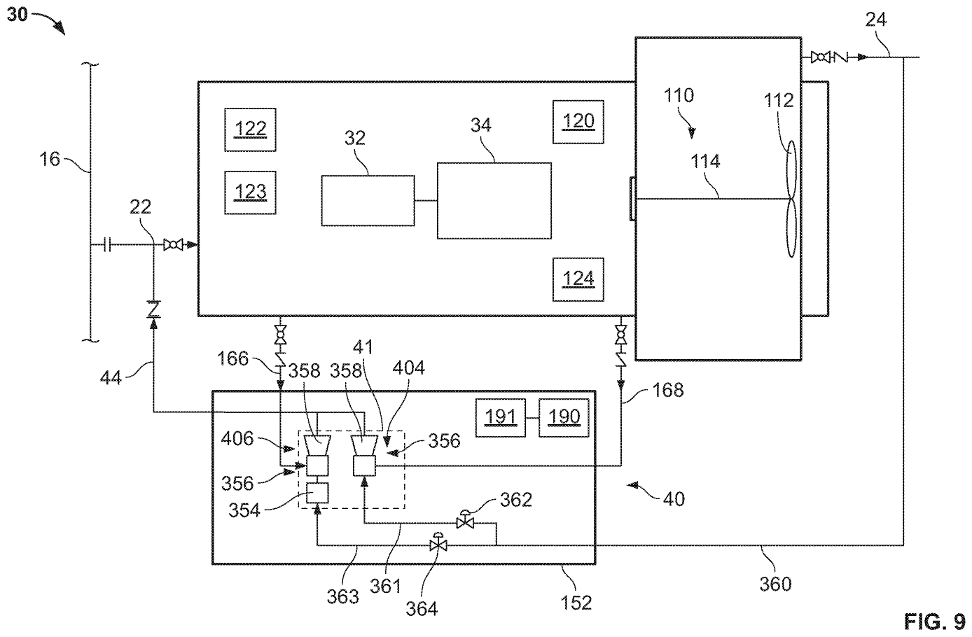

Referring now to FIG. 9, another embodiment of an emissions management module 40 of a natural gas system are shown in greater detail. The emissions management module 40 shown in FIG. 9 may comprise one or more of the emissions management modules 40. Natural gas system 10 includes upstream pipeline 12, downstream pipeline 14, discharge header 18, process suction conduit 22, process discharge conduit 24, compressor 32, piston rod assembly 33, driver 34, emissions management module 40, VRU 41, and emissions inlet conduit 42 as shown in natural gas system 10 shown in FIG. 1. In this exemplary embodiment, compressor package 30 generally includes a driver 34 and a reciprocating compressor 32 driven by the driver 34. Emissions management module 40 includes features in common with emissions management module 40 shown in FIG. 8, and shared features are labeled similarly.

In this exemplary embodiment, emissions management module 40 comprises a natural gas powered VRU 41 which includes a pair of fluid or gas circulators 404 and 406 for capturing and directing different types of emissions from the compressor package 30. Each of the gas circulators 404 and 406 comprises a separate or dedicated gas ejector 356 and nozzle-diffuser assembly 358. Additionally, gas circulator 406 comprises a suction tank 354. It may be understood that in other embodiments the configuration of gas circulator 404 and/or 406 may vary from that shown in FIG. 9. A first gas circulator 404 of the pair of gas circulators 404, 406 corresponds to a high-pressure circuit of the VRU 41 while a second gas circulator 406 of the pair of gas circulators 404, 406 corresponds to a low-pressure circuit of the VRU 41 which receives emissions from compressor package 30 that are generally of a lower pressure than the emissions received by the high-pressure circuit of VRU 41. For example, the first or high-pressure gas circulator 404 of VRU 41 may receive blowdown emissions from compressor package 30 while the second or low-pressure gas circulator 406 may receive packing or other generally low-pressure emissions from compressor package 30. In this configuration, VRU 41 includes a high-pressure circuit comprising the high-pressure gas circulator 404 and a low-pressure circuit, separate from the high-pressure circuit, comprising the low-pressure gas circulator 406. Providing VRU 41 with two distinct emissions recovery circuits (the high-and low-pressure circuits thereof) may allow for the low-pressure circuit of VRU 41 to be maintained at negative or vacuum pressure, preventing captured emissions circulating through the low-pressure circuit of VRU 41 from escaping to the surrounding atmosphere. Indeed, in some embodiments VRU 41 is configured to maintain second emissions inlet conduit 168 under a vacuum such that second emissions inlet conduit 168 and the systems of compressor package 30 in fluid communication therewith (e.g., seal system 122, vent system 123) may not be exposed to positive pressure.

The ability to maintain the low-pressure circuit of VRU 41 under vacuum may allow compressor package 30 to operate a closed vent packing system which, under some regulatory authorities, may permit less frequent inspecting of the compressor package 30 and thus a reduction in costs associated with the operation of compressor package 30. Additionally, a greater variety of emissions including, for example, emissions associated with instrument gas (which cannot be exposed to positive pressure) of compressor package 30 may be captured by the low-pressure circuit of VRU 41 when the low-pressure circuit is maintained under vacuum.

In this exemplary embodiment, motive fluid conduit 360 branches into a first branch conduit 361 associated with the high-pressure circuit of VRU 41 and a second branch conduit 363 associated with the low-pressure circuit of VRU 41, where a corresponding branch valve 362 and 364 is disposed along the branch conduits 361 and 363, respectively. In this arrangement, motive fluid in the form of pressurized natural gas from discharge conduit 24 may be supplied separately to the high-pressure and low-pressure circuits of VRU 41. Additionally, branch valves 362 and 364 permit the high-pressure and low-pressure circuits of VRU 41 to be selectably isolated from discharge conduit 24. In this exemplary embodiment, pressurized natural gas is supplied from a first branch conduit 361 of the pair of branch conduits 361, 363 to the high-pressure gas circulator 404 while pressurized natural gas may be supplied from a second branch conduit 363 of the pair of branch conduits 361, 363 to the gas ejector 356 of low-pressure gas circulator 406; however, it may be understood that in other embodiments the manner in which the pressurized natural gas is supplied to gas circulators 404 and 406 may vary from the arrangement shown in FIG. 9.

In this exemplary embodiment, first emissions inlet conduit 166 is routed from the compressor package 30 to the low-pressure gas circulator 406 and thus is associated with the low-pressure circuit of VRU 41. Particularly, first emissions inlet conduit 166 connects with the suction tank 354 of the low-pressure gas circulator 406 to route low-pressure emissions from the compressor package 30 to the low-pressure gas circulator 406. Additionally, in this exemplary embodiment, second emissions inlet conduit 168 is routed from the compressor package 30 to the high-pressure gas circulator 404 and thus is associated with the high-pressure circuit of VRU 41. Specifically, second emissions inlet conduit 168 connects to the gas ejector 356 of the high-pressure gas circulator 404 to route high-pressure emissions from the compressor package 30 to the high-pressure gas circulator 404. It may be understood that the manner in which first emissions inlet conduit 166 is routed to the low-pressure gas circulator 406 and the manner in which second emissions inlet conduit 168 is routed to high-pressure gas circulator 404 may vary from the arrangement shown in FIG. 9.

Further, in this exemplary embodiment, discharge conduit 44 is routed in parallel from the discharge of the nozzle-diffuser assembly 358 of each gas circulator 404, 406 to the suction conduit 22 associated with the compressor package 30. However, it may be understood that in other embodiments the captured emissions discharged from the high-and/or low-pressure circuits of VRU 41 may be routed to locations other than suction conduit 22, including the fuel system of compressor package 30.

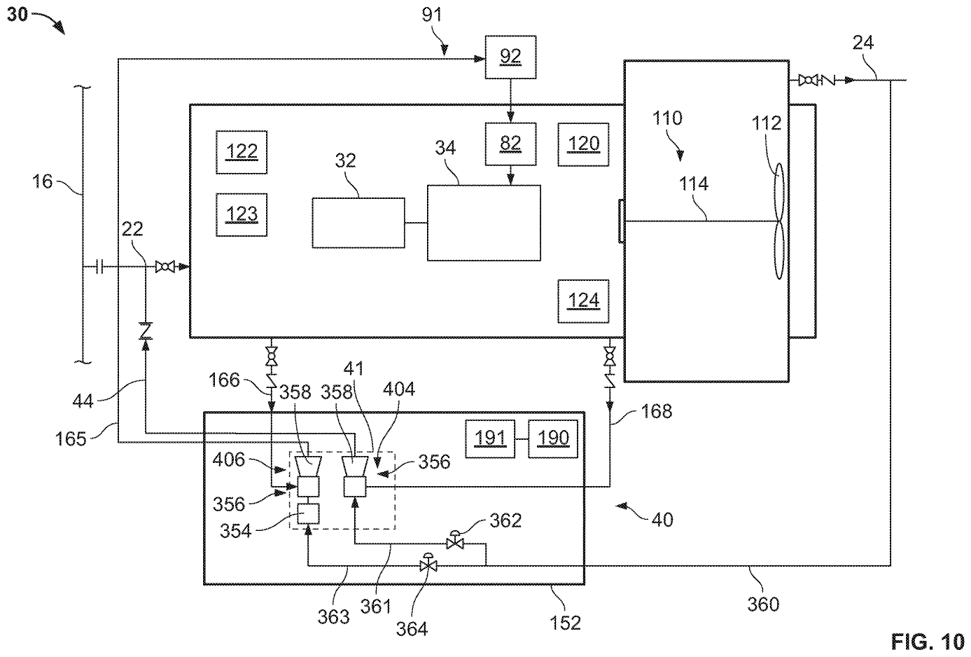

As an example, and referring now to FIG. 10, another embodiment of an emissions management module 40 of a natural gas system is shown along with an embodiment of a compressor package 30 from which the emissions management module 40 captures emissions. Natural gas system 10 includes upstream pipeline 12, downstream pipeline 14, discharge header 18, process suction conduit 22, process discharge conduit 24, compressor 32, piston rod assembly 33, driver 34, emissions management module 40, VRU 41, and emissions inlet conduit 42 as shown in natural gas system 10 shown in FIG. 1. In this exemplary embodiment, compressor package 30 generally includes a driver 34 and a reciprocating compressor 32 driven by the driver 34. As shown in FIG. 10, compressor package 30 includes a fuel gas conditioner 82 as described above which is connected to a fuel header 92 of fuel system 91 of a natural gas system (e.g., fuel system 91 of the natural gas system 10 shown in FIG. 3).

The emissions management module 40 shown in FIG. 10 may comprise one or more of the emissions management modules 40. Additionally, emissions management module 40 includes features in common with emissions management module 40 shown in FIG. 9, and shared features are labeled similarly. Particularly, emissions management module 40 in FIG. 10 is similar to module 40 in FIG. 9 except that only the emissions discharged from the high-pressure circuit of VRU 41 thereof are routed by discharge conduit 44 to the suction conduit 22. In this exemplary embodiment, the emissions discharged from the low-pressure circuit of the VRU 41 of emissions management module 40 are routed by a second or fuel discharge conduit 165 from the discharge of the nozzle-diffuser assembly 358 of the low-pressure gas circulator 406 to the fuel header 92, where at least some of the emissions may be directed from the fuel header 92 to the fuel gas conditioner 82 of compressor package 30 prior to being consumed by the driver 34 of compressor package 30.

While in this exemplary embodiment the high-pressure circuit of the VRU 41 of emissions management module 40 is connected to the suction conduit 22 while the low-pressure circuit of VRU 41 is connected to the fuel system 91, in other embodiments the arrangement of the high-and low-pressure circuits of VRU 41 may be reversed, with the high-pressure circuit of VRU 41 connected to the fuel system 91 and the low-pressure circuit of VRU 41 connected to suction conduit 22. Alternatively, both the high-pressure circuit and low-pressure circuit of VRU 41 may be connected to the fuel system 91.

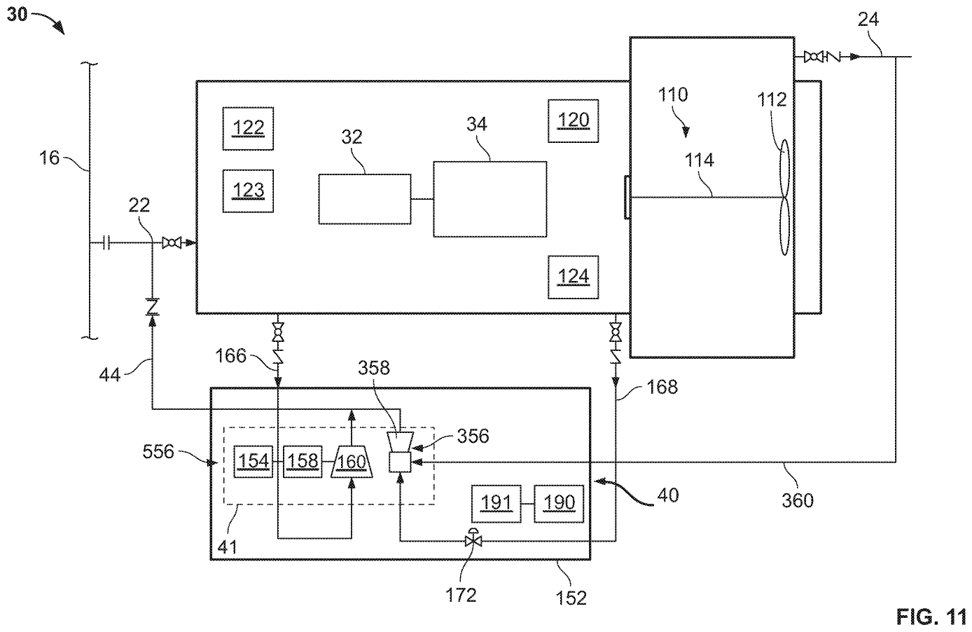

Referring now to FIG. 11, another embodiment of an emissions management module 40 of a natural gas system is shown. The emissions management module 40 shown in FIG. 11 may comprise one or more of the emissions management modules 40. Natural gas system 10 includes upstream pipeline 12, downstream pipeline 14, discharge header 18, process suction conduit 22, process discharge conduit 24, compressor 32, piston rod assembly 33, driver 34, emissions management module 40, VRU 41, and emissions inlet conduit 42 as shown in natural gas system 10 shown in FIG. 1. In this exemplary embodiment, compressor package 30 generally includes a driver 34 and a reciprocating compressor 32 driven by the driver 34. Additionally, emissions management module 40 includes features in common with emissions management modules 40 shown in FIG. 5 and FIG. 9, including support structure 152, onboard power source 154, gas circulator motor 158, gas circulator compressor 160, first emissions inlet conduit 166, second emissions inlet conduit 168, LP blowdown valve 172, motive fluid conduit 360, and nozzle-diffuser assembly 358; shared features are labeled similarly.

Particularly, in this exemplary embodiment, emissions management module 40 comprises a VRU 41 including a high-pressure circuit comprising the high-pressure gas circulator 404, and a low-pressure circuit that is separate from the high-pressure circuit and comprises a low-pressure gas circulator 556 that is different in configuration from the low-pressure gas circulator 406 (shown in FIG. 9) described above. Specifically, in this exemplary embodiment, low-pressure gas circulator 556 comprises gas circulator motor 158 and gas circulator compressor 160, where gas circulator motor 158 is powered by onboard power source 154 as described in greater detail above. It may be understood that while in this exemplary embodiment the low-pressure gas circulator 556 comprises gas circulator compressor 160, in other embodiments, the high-pressure gas circulator 404 of VRU 41 may instead comprise the gas circulator compressor 160 while the low-pressure gas circulator 556 may instead comprise the gas ejector 356.

Additionally, in this exemplary embodiment, both the low-pressure and high-pressure circuits of VRU 41 discharge into the suction conduit 22 associated with compressor package 30 through the discharge conduit 44 which is connected in parallel to the discharge of both the high-pressure gas circulator 404 and the low-pressure gas circulator 556 of the VRU 41 of emissions management module 40. It may be understood of course that the emissions discharged from high-pressure gas circulator 404 and/or low-pressure gas circulator 556 may be directed to locations other than the suction conduit 22.

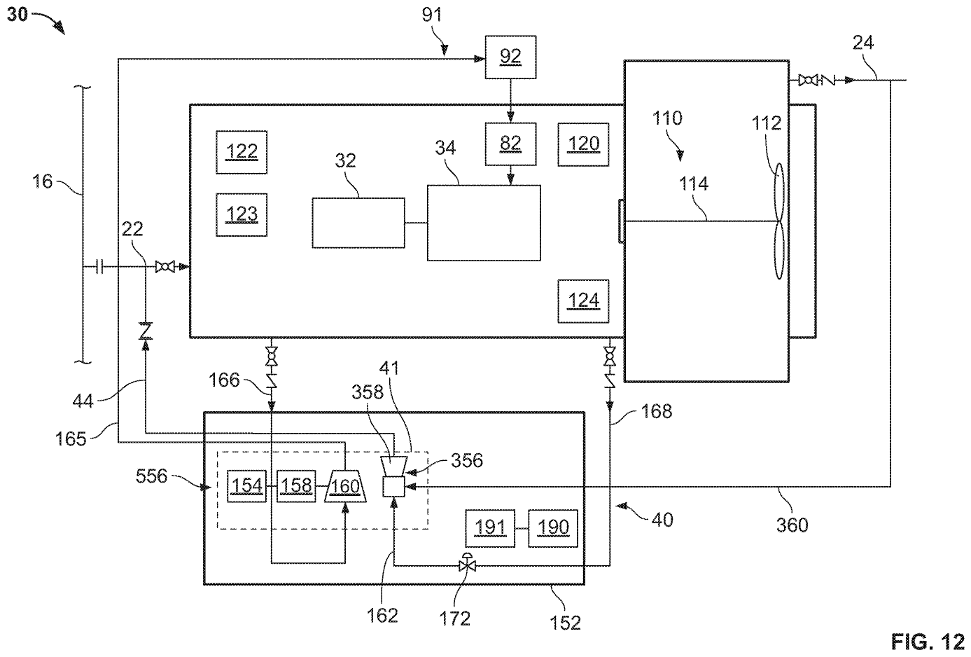

As an example, and referring now to FIG. 12, another embodiment of an emissions management module 40 of a natural gas system is shown. The emissions management module 40 shown in FIG. 12 may comprise one or more of the emissions management modules 40. Natural gas system 10 includes upstream pipeline 12, downstream pipeline 14, discharge header 18, process suction conduit 22, process discharge conduit 24, compressor 32, piston rod assembly 33, driver 34, emissions management module 40, VRU 41, and emissions inlet conduit 42 as shown in natural gas system 10 shown in FIG. 1. In this exemplary embodiment, compressor package 30 generally includes a driver 34 and a reciprocating compressor 32 driven by the driver 34. Additionally, emissions management module 40 includes features in common with emissions management module 40 shown in FIG. 11, and shared features are labeled similarly. Particularly, emissions management module 40 is similar to the module 40 of FIG. 11 except that emissions discharged from the high-pressure gas circulator 404 of the VRU 41 of emissions management module 40 is routed to the suction conduit 22 by discharge conduit 44 while emissions discharged from the low-pressure gas circulator 556 (comprising gas circulator compressor 160 in this exemplary embodiment) is routed to fuel header 92 by the fuel discharge conduit 165. It may be understood of course that in other embodiments the high-pressure gas circulator 404 of VRU 41 may discharge to the fuel header 92 while the low-pressure gas circulator 556 may discharge to the suction conduit 22.

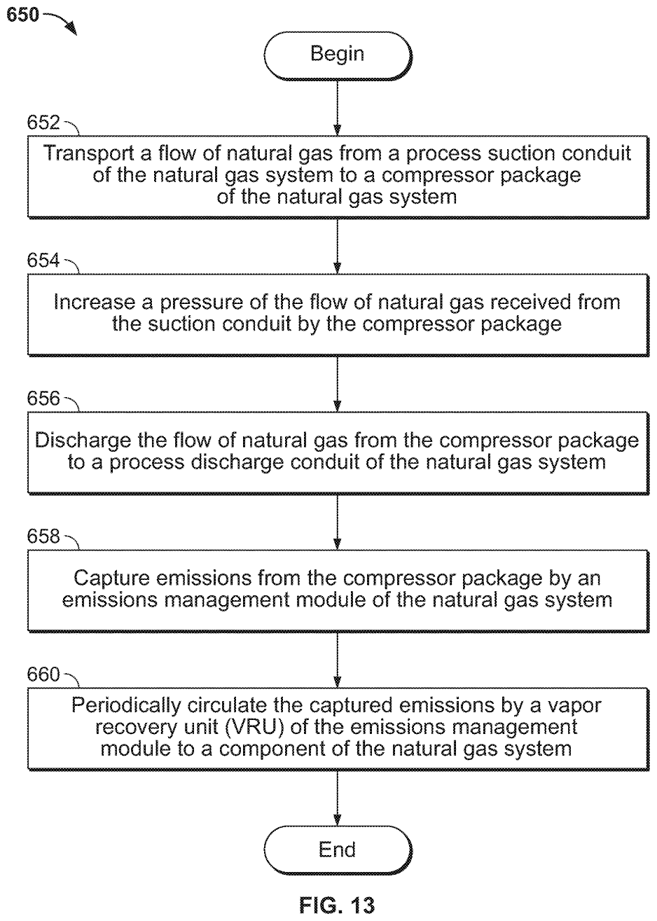

Referring to FIG. 13, an embodiment of a method 650 for capturing emissions from a compressor package of a natural gas system is shown. Beginning at block 652, method 650 comprises transporting a flow of natural gas from a process suction conduit of the natural gas system to a compressor package of the natural gas system. In some embodiments, block 652 comprises transporting a flow of natural gas from the suction header 16 and/or suction conduit 22 of the natural gas system 10 to one of the compressor packages 30 as shown in FIG. 1 through FIG. 8, respectively.

At block 654, method 650 comprises increasing a pressure of the flow of natural gas received from the suction conduit by the compressor package. In some embodiments, block 654 comprises increasing a pressure of the flow of natural gas received from the suction header 16 and/or suction conduit 22 by the compressor package 30. In some embodiments, block 654 comprises increasing the pressure of the flow of natural gas by the compressor package 30 shown in FIG. 5, FIG. 6, FIG. 7, or FIG. 8. At block 656, method 650 comprises discharging the flow of natural gas from the compressor package to a discharge conduit of the natural gas system. In some embodiments, block 656 comprises discharging the flow of natural gas from compressor package 30 shown in FIG. 5 through FIG. 8, to the discharge conduit 24/discharge header 18.

At block 658, method 650 comprises capturing emissions from the compressor package by an emissions management module of the natural gas system. In some embodiments, block 658 comprises capturing emissions from the compressor packages 30 by the emissions management modules 40 shown in FIG. 1 through FIG. 12, respectively.

At block 660, method 650 comprises periodically circulating the captured emissions by a vapor recovery unit (VRU) of the emissions management module to a component of the natural gas system. In some embodiments, block 660 comprises circulating the captured emissions to the suction conduit of the natural gas system. In some embodiments, block 660 comprises circulating the captured emissions to a driver of the compressor package such as a fuel filter of the driver whereby the captured emissions may be consumed as fuel by the driver. In some embodiments, block 660 comprises circulating the captured emissions to a hydrocarbon processing component of the natural gas system separate from the compressor package and which processes a process gas (e.g., natural gas) of the natural gas system.

In some embodiments, block 660 comprises circulating the captured emissions by the VRU 41 of the emissions management module 40 to the suction header 16 and/or suction conduit 22 shown in FIG. 1 through FIG. 12.

### Certain Embodiments

Disclosed is a methane emissions mitigation solution designed to capture the fugitive methane emissions including but not limited to the blowdown, the pneumatic control gas system, and/or the compressor rod packings of natural gas compressor package. In a first aspect, the methane mitigation solution comprises a natural gas system. In a first set of embodiments, the natural gas system comprises:
a) a process suction conduit;
b) a compressor package connected downstream of the process suction conduit and configured to receive a flow of natural gas from the process suction conduit and to increase a pressure of the flow of natural gas whereby the flow of natural gas is discharged from the compressor package as a pressurized flow of natural gas;
c) a process discharge conduit connected downstream of the compressor package and configured to receive the flow of natural gas discharged from the compressor package; and
d) an emissions management module (EMM) coupled to the compressor package and configured to capture emissions from the compressor package, wherein the EMM comprises a vapor recovery unit (VRU) configured to periodically circulate the captured emissions from the VRU to an emissions discharge conduit.

In a second set of embodiments, in addition to the limitations of each of the foregoing embodiments of the first set of embodiments:
a) the EMM further comprises an emissions inlet conduit and a VRU control system;
b) the VRU comprises a circulator; and
c) the periodic circulation of the captured emissions from the VRU to the emissions discharge conduit is enabled by the VRU control system:
   i) activating the circulator to withdraw the captured emissions from the emissions inlet conduit when a pressure in the inlet conduit reaches an upper threshold value;
ii) circulating the withdrawn captured emissions from the emissions inlet conduit to the emissions discharge conduit, thereby reducing the pressure in the emissions inlet conduit; and
   iii) deactivating the circulator to terminate withdrawal of the captured emissions from the emissions inlet conduit when the pressure in the emissions inlet conduit reaches a lower threshold value.

In a third set of embodiments, in addition to the limitations of each of the foregoing embodiments of the second set of embodiments, the VRU control system deactivates the circulator if the pressure in the emissions inlet conduit does not reach the lower threshold within a preselected time period.

In a fourth set of embodiments, in addition to the limitations of each of the foregoing embodiments of the second and the third sets of embodiments:
a) the emissions inlet conduit fluidly connects the VRU to an emissions source having an initial pressure greater than the upper threshold value; wherein in further embodiments the ratio of the upper threshold value of pressure in the emissions inlet conduit to the pressure in the emissions discharge conduit (i.e., equivalent to operating pressure of the destination disposition) is:
   i) less than or equal to 2, less than or equal to 1.8, or less than or equal to 1.5;
   ii) greater than or equal to 1, greater than or equal to 1.1, or greater than or equal to 1.2; or
   iii) in a range of from 1 to 2, from 1.1 to 1.8, or from 1.2 to 1.5.
b) the captured emissions flow from the emissions source to the emissions discharge conduit based on differential pressure until the pressure in the emissions inlet conduit reaches the upper threshold value; and
c) the lower threshold pressure is selected to facilitate removal of at least 80 vol %, at least 85 vol %, at least 90 vol %, or at least 95 vol % of the contents of the equipment being cleared and circulation to the destination disposition.

In a fifth set of embodiments, in addition to the limitations of each of the foregoing embodiments of the fourth set of embodiments, the captured emissions comprise emissions from an emissions source at a pressure greater than or equal to 30 psia (207 kPaa).

In a sixth set of embodiments, in addition to the limitations of each of the foregoing embodiments of the fourth and the fifth sets of embodiments, the captured emissions comprise emissions related to shutdown of the compressor package, shutdown of a hydrocarbon processing component in the natural gas system other than the compressor package, or a combination thereof.

In a seventh set of embodiments, in addition to the limitations of each of the foregoing embodiments of the fourth through the sixth sets of embodiments, the captured emissions comprise emissions from a blowdown system of the compressor package, a blowdown system of the natural gas system other than the blowdown system of the compressor package, or a combination thereof.

In an eighth set of embodiments, in addition to the limitations of each of the foregoing embodiments of the second through the seventh sets of embodiments:
a) the emissions inlet conduit fluidly connects the VRU to an emissions source having an initial pressure less than the upper threshold value; wherein in further embodiments, the upper threshold value is in a range of from twice the lower threshold value to less than the pressure in the emissions discharge conduit; and
b) the captured emissions accumulate in the emissions inlet conduit until the pressure in the emissions inlet conduit reaches the upper threshold value.

In a ninth set of embodiments, in addition to the limitations of each of the foregoing embodiments of the eighth set of embodiments, the inlet conduit further comprises a suction tank.

In a tenth set of embodiments, in addition to the limitations of each of the foregoing embodiments of the eighth and ninth sets of embodiments, the VRU is configured to maintain the emissions inlet conduit at a pressure less than or equal to 1 atmosphere.

In an eleventh set of embodiments, in addition to the limitations of each of the foregoing embodiments of the eighth through the tenth sets of embodiments, the captured emissions comprise emissions from an emissions source at a pressure less than or equal to 30 psia (207 kPaa).

In a twelfth set of embodiments, in addition to the limitations of each of the foregoing embodiments of the eighth through the eleventh sets of embodiments, the captured emissions comprise emissions from the compressor package when in operation, a hydrocarbon processing component in the natural gas system in operation other than the compressor package, or a combination thereof.

In a thirteenth set of embodiments, in addition to the limitations of each of the foregoing embodiments of the eighth through the twelfth sets of embodiments, the captured emissions comprise emissions from a seal system of the compressor package, a vent system of the compressor package, a vent system of the natural gas system other than the vent system of the compressor package, or a combination thereof.

In a fourteenth set of embodiments, in addition to the limitations of each of the foregoing embodiments of the first through the thirteenth sets of embodiments of the natural gas system, the emissions discharge conduit delivers the captured emissions to a hydrocarbon processing component in the natural gas system operating at a pressure less than or equal to 30 psia (207 kPaa).

In a fifteenth set of embodiments, in addition to the limitations of each of the foregoing embodiments of the first through the fourteenth sets of embodiments, the emissions discharge conduit delivers the captured emissions to the process suction conduit, a fuel gas system of the natural gas system, a hydrocarbon processing component that is separate from the compressor package, or a combination thereof.

In a sixteenth set of embodiments, in addition to the limitations of each of the foregoing embodiments of the second through the fifteenth sets of embodiments, the circulator comprises a compressor and a motor configured to drive the compressor,

In a seventeenth set of embodiments, in addition to the limitations of each of the foregoing embodiments of the sixteenth set of embodiments, the EMM comprises a support structure, and a power source supported on the support structure and configured to power the motor of the circulator.

In an eighteenth set of embodiments, in addition to the limitations of each of the foregoing embodiments of the sixteenth and the seventeenth sets of embodiments, the motor of the circulator is configured to receive electrical energy from an electrical power grid.

In a nineteenth set of embodiments, in addition to the limitations of each of the foregoing embodiments of the first through the eighteenth sets of embodiments, the compressor package comprises a cooling system comprising a fan and a driveshaft driven by the compressor and configured to rotate the fan.

In a twentieth set of embodiments, in addition to the limitations of each of the foregoing embodiments of the first through the nineteenth sets of embodiments, the compressor package comprises an electrical power source comprising an electrical generator and a driveshaft driven by the compressor and configured to drive the electrical generator.

In a twenty-first set of embodiments, in addition to the limitations of each of the foregoing embodiments of the second through the fifteenth sets of embodiments, the circulator comprises a gas ejector powered by a motive fluid flow.

In a twenty-second set of embodiments, in addition to the limitations of each of the foregoing embodiments of the twenty-first set of embodiments, the motive fluid flow comprises a flow of natural gas from the process discharge conduit.

In a twenty-third set of embodiments, in addition to the limitations of each of the foregoing embodiments of the first through the twenty-second sets of embodiments:
a) the EMM comprises a support structure on which the VRU is supported; and
b) the support structure comprises a road transportable skid.

In a twenty-fourth set of embodiments, in addition to the limitations of each of the foregoing embodiments of the first through the twenty-third sets of embodiments, a plurality of the compressor packages are arranged in parallel with respect to each other, and a plurality of the EMMs, wherein each of the EMMs is associated with one of the plurality of the compressor packages.

In a twenty-fifth set of embodiments, in addition to the limitations of each of the foregoing embodiments of the first through the twenty-fourth sets of embodiments:
a) a high-pressure circuit comprises a high-pressure gas circulator configured to receive a first stream of emissions from the compressor package; and
b) a low-pressure circuit comprises a low-pressure gas circulator configured to receive a second stream of emissions from the compressor package.

In a twenty-sixth set of embodiments, in addition to the limitations of each of the foregoing embodiments of the twenty-fifth set of embodiments;
a) the high-pressure gas circulator comprises a high-pressure compressor or a high-pressure gas ejector; and
b) the low-pressure gas circulator comprises a low-pressure compressor or a low-pressure gas ejector.

In a twenty-seventh set of embodiments, in addition to the limitations of each of the foregoing embodiments of the twenty-fifth through the twenty-sixth sets of embodiments, one of the high-pressure gas circulator and the low-pressure gas circulator discharges into a fuel gas system of the compressor package, a fuel gas system of the natural gas system other than the fuel gas system of the compressor package, or a combination thereof.

In a twenty-eighth set of embodiments, in addition to the limitations of each of the foregoing embodiments of the first through the twenty-seventh sets of embodiments:
a) the compressor package comprises a first compressor package of a plurality of compressor packages of the natural gas system; and
b) the EMM is connected to the plurality of compressor packages in parallel whereby the emissions management module is configured to the capture emissions from each of the plurality of compressor packages.

In a second aspect, the methane mitigation solution comprises an emissions management module for a natural gas system. In a twenty-ninth set of embodiments, the emissions management module for a natural gas system comprises:
a) a support structure;
b) a high-pressure emissions inlet conduit supported on the support structure and configured to receive a high-pressure stream of emissions from the natural gas system;
c) a low-pressure emissions inlet conduit supported on the support structure and configured to receive a low-pressure stream of emissions from the natural gas system;
d) a vapor recovery unit (VRU) supported on the support structure and connected to both the high-pressure emissions inlet conduit and the low-pressure emissions inlet conduit; and
e) a high-pressure emissions discharge conduit and a low-pressure emissions discharge conduit connected to the VRU, wherein the VRU is configured to periodically circulate the high-pressure stream of emissions and/or the low-pressure stream of emissions from the VRU to a component of the natural gas system.

In a thirtieth set of embodiments, in addition to the limitations of each of the foregoing embodiments of the twenty-ninth set of embodiments of the EMM:
a) the VRU comprises a circulator; and
b) the periodic circulation of the captured emissions from the VRU to the low-pressure emissions discharge conduit or the high-pressure emissions discharge conduit is enabled by the VRU control system:
   i) activating the circulator to withdraw the captured emissions from the low-pressure emissions inlet conduit or the high-pressure emissions inlet conduit, respectively, when a pressure in the low-pressure emissions inlet conduit or the high-pressure emissions inlet conduit, respectively, reaches an upper threshold value;
ii) circulating the withdrawn captured emissions from the low-pressure emissions inlet conduit or the high-pressure emissions inlet conduit, respectively, to the low-pressure emissions discharge conduit or the high-pressure emissions discharge conduit, respectively, thereby reducing the pressure in the low-pressure emissions inlet conduit or the high-pressure emissions inlet conduit, respectively; and
   iii) deactivating the circulator to terminate withdrawal of the captured emissions from the low-pressure emissions inlet conduit or the high-pressure emissions inlet conduit, respectively, when the pressure in the low-pressure emissions inlet conduit or the high-pressure emissions inlet conduit, respectively, reaches a lower threshold value.

In a thirty-first set of embodiments, in addition to the limitations of each of the foregoing embodiments of the thirtieth set of embodiments, the VRU control system deactivates the circulator if the pressure in the low-pressure emissions inlet conduit or the high-pressure emissions inlet conduit, respectively, does not reach the lower threshold within a preselected time period.

In a thirty-second set of embodiments, in addition to the limitations of each of the foregoing embodiments of the twenty-ninth through the thirty first sets of embodiments:
a) the emissions inlet conduit fluidly connects the VRU to an emissions source having an initial pressure greater than the upper threshold value; wherein in further embodiments the ratio of the upper threshold value of pressure in the emissions inlet conduit to the pressure in the emissions discharge conduit (i.e., equivalent to operating pressure of the destination disposition) is:
   i) less than or equal to 2, less than or equal to 1.8, or less than or equal to 1.5;
   ii) greater than or equal to 1, greater than or equal to 1.1, or greater than or equal to 1.2; or
   iii) in a range of from 1 to 2, from 1.1 to 1.8, or from 1.2 to 1.5.
b) the captured emissions flow from the emissions source to the emissions discharge conduit based on differential pressure until the pressure in the emissions inlet conduit reaches the upper threshold value; and
c) the lower threshold pressure is selected to facilitate removal of at least 80 vol %, at least 85 vol %, at least 90 vol %, or at least 95 vol % of the contents of the equipment being cleared and circulation to the destination disposition.

In a thirty-third set of embodiments, in addition to the limitations of each of the foregoing embodiments of the thirty-second set of embodiments, the captured emissions comprise emissions from an emissions source at a pressure greater than or equal to 30 psia (207 kPaa).

In a thirty-fourth set of embodiments, in addition to the limitations of each of the foregoing embodiments of the thirty-second and thirty-third sets of embodiments, the captured emissions comprise emissions related to shutdown of a compressor package, shutdown of a hydrocarbon processing component in the natural gas system other than the compressor package, or a combination thereof.

In a thirty-fifth set of embodiments, in addition to the limitations of each of the foregoing embodiments of the thirty-second and thirty-fourth sets of embodiments, the captured emissions comprise emissions from a blowdown system of a compressor package, a blowdown system of the natural gas system other than the blowdown system of the compressor package, or a combination thereof.

In a thirty-sixth set of embodiments, in addition to the limitations of each of the foregoing embodiments of the twenty-ninth and thirty-fifth sets of embodiments:
a) the emissions inlet conduit fluidly connects the VRU to an emissions source having an initial pressure less than the upper threshold value; wherein in further embodiments, the upper threshold value is in a range of from twice the lower threshold value to less than the pressure in the emissions discharge conduit; and
b) the captured emissions accumulate in the low-pressure emissions inlet conduit until the pressure in the low-pressure emissions inlet conduit reaches the upper threshold value.

In a thirty-seventh set of embodiments, in addition to the limitations of each of the foregoing embodiments of the thirty-sixth set of embodiments, the low-pressure emissions inlet conduit further comprises a suction tank.

In a thirty-eighth set of embodiments, in addition to the limitations of each of the foregoing embodiments of the thirty-sixth and thirty-seventh sets of embodiments, the VRU is configured to maintain the low-pressure emissions inlet conduit at a pressure less than or equal to 1 atmosphere.

In a thirty-ninth set of embodiments, in addition to the limitations of each of the foregoing embodiments of the thirty-sixth through the thirty-eighth sets of embodiments, the captured emissions comprise emissions from an emissions source at a pressure less than or equal to 30 psia (207 kPaa).

In a fortieth set of embodiments, in addition to the limitations of each of the foregoing embodiments of the thirty-sixth through the thirty-ninth sets of embodiments, the captured emissions comprise emissions from a compressor package when in operation, a hydrocarbon processing component in the natural gas system in operation other than the compressor package, or a combination thereof.

In a forty-first set of embodiments, in addition to the limitations of each of the foregoing embodiments of the thirty-sixth through the fortieth sets of embodiments, the captured emissions comprise emissions from a seal system of a compressor package, a vent system of the compressor package, a vent system of the natural gas system other than the vent system of the compressor package, or a combination thereof.

In a forty-second set of embodiments, in addition to the limitations of each of the foregoing embodiments of the twenty-ninth through the forty-first sets of embodiments, the low-pressure emissions discharge conduit and/or the high-pressure emissions discharge conduit delivers the captured emissions to a hydrocarbon processing component in the natural gas system operating at a pressure less than or equal to 30 psia (207 kPaa).

In a forty-third set of embodiments, in addition to the limitations of each of the foregoing embodiments of the twenty-ninth through the forty-second sets of embodiments, the low-pressure emissions discharge conduit and/or the high-pressure emissions discharge conduit delivers the captured emissions to a process suction conduit of a compressor package, a fuel gas system of the natural gas system, a hydrocarbon processing component that is separate from the compressor package, or a combination thereof.

In a forty-fourth set of embodiments, in addition to the limitations of each of the foregoing embodiments of the thirtieth through the forty-third sets of embodiments, the circulator comprises a compressor and a motor configured to drive the compressor.

In a forty-fifth set of embodiments, in addition to the limitations of each of the foregoing embodiments of the forty-fourth set of embodiments, the EMM further comprises a power source supported on the support structure and configured to power the motor of the circulator.

In a forty-sixth set of embodiments, in addition to the limitations of each of the foregoing embodiments of the forty-fourth and forty-fifth sets of embodiments, the motor of the circulator is configured to receive electrical energy from an electrical power grid.

In a forty-seventh set of embodiments, in addition to the limitations of each of the foregoing embodiments of the thirtieth and forty-third sets of embodiments, the circulator comprises a gas ejector powered by a motive fluid flow.

In a forty-eighth set of embodiments, in addition to the limitations of each of the foregoing embodiments of the forty-seventh set of embodiments, the motive fluid flow comprises a flow of natural gas from a process discharge conduit of a compressor package.

In a forty-ninth set of embodiments, in addition to the limitations of each of the foregoing embodiments of the twenty-ninth through the forty-eighth sets of embodiments, the support structure comprises a road transportable skid.

In a fiftieth set of embodiments, in addition to the limitations of each of the foregoing embodiments of the thirtieth through the forty-ninth sets of embodiments:
a) a high-pressure circuit comprising a high-pressure gas circulator configured to receive a first stream of emissions from the compressor package; and
b) a low-pressure circuit comprising a low-pressure gas circulator configured to receive a second stream of emissions from the compressor package.

In a fifty-first set of embodiments, in addition to the limitations of each of the foregoing embodiments of the fiftieth set of embodiments:
a) the high-pressure gas circulator comprises a high-pressure compressor or a high-pressure gas ejector; and
b) the low-pressure gas circulator comprises a low-pressure compressor or a low-pressure gas ejector.

In a fifty-second set of embodiments, in addition to the limitations of each of the foregoing embodiments of the fiftieth and fifty-first sets of embodiments, the high-pressure gas circulator and/or the low-pressure gas circulator discharges into a fuel gas system of a compressor package, a fuel gas system of the natural gas system other than the fuel gas system of the compressor package, or a combination thereof.

In a third aspect, the methane mitigation solution comprises a method for capturing emissions from a compressor package of a natural gas system. In a fifty-third set of embodiments, the method for capturing emissions from a compressor package of a natural gas system comprises:
(a) transporting a flow of natural gas from a process suction conduit of the natural gas system to a compressor package of the natural gas system;
(b) increasing a pressure of the flow of natural gas received from the process suction conduit by the compressor package;
(c) discharging the flow of natural gas from the compressor package to a process discharge conduit of the natural gas system;
(d) capturing emissions from the compressor package in an emissions inlet conduit of an emissions management module (EMM) of a natural gas system; and
(e) periodically circulating the captured emissions by a vapor recovery unit (VRU) of the EMM to the process suction conduit, a fuel gas system of the natural gas system, a hydrocarbon processing component that is separate from the com-pressor package, or a combination thereof.

In a fifty-fourth set of embodiments, in addition to the limitations of each of the foregoing embodiments of the fifty-third set of embodiments:
a) the EMM further comprises an emissions inlet conduit and a VRU control system;
b) the VRU comprises a circulator;
c) the periodic circulation of the captured emissions from the VRU to the emissions discharge conduit is enabled by the VRU control system:
   i) activating the circulator to withdraw the captured emissions from the emissions inlet conduit when a pressure in the inlet conduit reaches an upper threshold value;
   ii) circulating the withdrawn captured emissions from the emissions inlet conduit to the emissions discharge conduit, thereby reducing the pressure in the emissions inlet conduit; and
d) deactivating the circulator to terminate withdrawal of the captured emissions from the emissions inlet conduit when the pressure in the emissions inlet conduit reaches a lower threshold value.

In a fifty-fifth set of embodiments, in addition to the limitations of each of the foregoing embodiments of the fifty-fourth set of embodiments, the VRU control system deactivates the circulator if the pressure in the emissions inlet conduit does not reach the lower threshold within a preselected time period.

In a fifty-sixth set of embodiments, in addition to the limitations of each of the foregoing embodiments of the fifty-fourth and fifty-fifth sets of embodiments:
a) the emissions inlet conduit fluidly connects the VRU to an emissions source having an initial pressure greater than the upper threshold value; wherein in further embodiments the ratio of the upper threshold value of pressure in the emissions inlet conduit to the pressure in the emissions discharge conduit (i.e., equivalent to operating pressure of the destination disposition) is:
   i) less than or equal to 2, less than or equal to 1.8, or less than or equal to 1.5;
   ii) greater than or equal to 1, greater than or equal to 1.1, or greater than or equal to 1.2; or
   iii) in a range of from 1 to 2, from 1.1 to 1.8, or from 1.2 to 1.5;
b) the captured emissions flow from the emissions source to the emissions discharge conduit based on differential pressure until the pressure in the emissions inlet conduit reaches the upper threshold value; and
c) the lower threshold pressure is selected to facilitate removal of at least 80 vol %, at least 85 vol %, at least 90 vol %, or at least 95 vol % of the contents of the equipment being cleared and circulation to the destination disposition.

In a fifty-seventh set of embodiments, in addition to the limitations of each of the foregoing embodiments of the fifty-sixth set of embodiments, the captured emissions comprise emissions from an emissions source at a pressure greater than or equal to 30 psia (207 kPaa).

In a fifty-eighth set of embodiments, in addition to the limitations of each of the foregoing embodiments of the fifty-sixth and fifty-seventh sets of embodiments, the captured emissions comprise emissions related to shutdown of the compressor package, shutdown of a hydrocarbon processing component in the natural gas system other than the compressor package, or a combination thereof.

In a fifty-ninth set of embodiments, in addition to the limitations of each of the foregoing embodiments of the fifty-sixth through the fifty-eighth sets of embodiments, the captured emissions comprise emissions from a blowdown system of the compressor package, a blowdown system of the natural gas system other than the blowdown system of the compressor package, or a combination thereof.

In a sixtieth set of embodiments, in addition to the limitations of each of the foregoing embodiments of the fifty-fourth through the fifty-ninth sets of embodiments:
a) the emissions inlet conduit fluidly connects the VRU to an emissions source having an initial pressure less than the upper threshold value; wherein in further embodiments, the upper threshold value is in a range of from twice the lower threshold value to less than the pressure in the emissions discharge conduit; and
b) the captured emissions accumulate in the emissions inlet conduit until the pressure in the emissions inlet conduit reaches the upper threshold value.

In a sixty-first set of embodiments, in addition to the limitations of each of the foregoing embodiments of the sixtieth set of embodiments, the inlet conduit further comprises a suction tank.

In a sixty-second set of embodiments, in addition to the limitations of each of the foregoing embodiments of the sixtieth and sixty-first sets of embodiments, the VRU is configured to maintain the emissions inlet conduit at a pressure less than or equal to 1 atmosphere.

In a sixty-third set of embodiments, in addition to the limitations of each of the foregoing embodiments of the sixtieth and sixty-second sets of embodiments, the captured emissions comprise emissions from an emissions source at a pressure less than or equal to 30 psia (207 kPaa).

In a sixty-fourth set of embodiments, in addition to the limitations of each of the foregoing embodiments of the sixtieth and sixty-third sets of embodiments, the captured emissions comprise emissions from the compressor package when in operation, a hydrocarbon processing component in the natural gas system in operation other than the compressor package, or a combination thereof.

In a sixty-fifth set of embodiments, in addition to the limitations of each of the foregoing embodiments of the sixtieth and sixty-fourth sets of embodiments, the captured emissions comprise emissions from a seal system of the compressor package, a vent system of the compressor package, a vent system of the natural gas system other than the vent system of the compressor package, or a combination thereof.

In a sixty-sixth set of embodiments, in addition to the limitations of each of the foregoing embodiments of the fifty-third through the sixty-fifth sets of embodiments, the emissions discharge conduit delivers the captured emissions to a hydrocarbon processing component in the natural gas system operating at a pressure less than or equal to 30 psia (207 kPaa).

In a sixty-seventh set of embodiments, in addition to the limitations of each of the foregoing embodiments of the fifty-third through the sixty-sixth sets of embodiments, the emissions discharge conduit delivers the captured emissions to the process suction conduit, a fuel gas system of the natural gas system, a hydrocarbon processing component that is separate from the compressor package, or a combination thereof.

In a sixty-eighth set of embodiments, in addition to the limitations of each of the foregoing embodiments of the fifty-fourth through the sixty-seventh sets of embodiments, the circulator comprises a compressor and a motor configured to drive the compressor.

In a sixty-ninth set of embodiments, in addition to the limitations of each of the foregoing embodiments of the sixty-eighth set of embodiments, the EMM comprises a support structure, and a power source supported on the support structure and configured to power the motor of the circulator.

In a seventieth set of embodiments, in addition to the limitations of each of the foregoing embodiments of the sixty-eighth and sixty-ninth sets of embodiments, the motor of the circulator is configured to receive electrical energy from an electrical power grid.

In a seventy-first set of embodiments, in addition to the limitations of each of the foregoing embodiments of the fifty-third through the seventieth sets of embodiments, the compressor package comprises a cooling system comprising a fan and a driveshaft driven by the compressor and configured to rotate the fan.

In a seventy-second set of embodiments, in addition to the limitations of each of the foregoing embodiments of the sixty-eighth through the seventy-first sets of embodiments, the compressor package comprises an electrical power source comprising an electrical generator and a driveshaft driven by the compressor and configured to drive the electrical generator.

In a seventy-third set of embodiments, in addition to the limitations of each of the foregoing embodiments of the fifty-fourth through the sixty-seventh sets of embodiments, the circulator comprises a gas ejector powered by a motive fluid flow.

In a seventy-fourth set of embodiments, in addition to the limitations of each of the foregoing embodiments of the seventy-third set of embodiments, the motive fluid flow comprises a flow of natural gas from the process discharge conduit.

In a seventy-fifth set of embodiments, in addition to the limitations of each of the foregoing embodiments of the fifty-third through the seventy-fourth sets of embodiments:
a) the EMM comprises a support structure on which the VRU is supported; and
b) the support structure comprises a road transportable skid.

In a seventy-sixth set of embodiments, in addition to the limitations of each of the foregoing embodiments of the fifty-third through the seventy-fifth sets of embodiments, a plurality of the compressor packages arranged in parallel with respect to each other, and a plurality of the EMMs, wherein each of the EMMs is associated with one of the plurality of the compressor packages.

In a seventy-seventh set of embodiments, in addition to the limitations of each of the foregoing embodiments of the fifty-third through the seventy-sixth sets of embodiments:
a) a high-pressure circuit comprising a high-pressure gas circulator configured to receive a first stream of emissions from the compressor package; and
b) a low-pressure circuit comprising a low-pressure gas circulator configured to receive a second stream of emissions from the compressor package.

In a seventy-eighth set of embodiments, in addition to the limitations of each of the foregoing embodiments of the seventy-seventh set of embodiments:
a) the high-pressure gas circulator comprises a high-pressure compressor or a high-pressure gas ejector; and
b) the low-pressure gas circulator comprises a low-pressure compressor or a low-pressure gas ejector.

In a seventy-ninth set of embodiments, in addition to the limitations of each of the foregoing embodiments of the seventy-seventh and seventy eighth sets of embodiments, one of the high-pressure gas circulator and the low-pressure gas circulator discharges into a fuel gas system of the compressor package, a fuel gas system of the natural gas system other than the fuel gas system of the compressor package, or a combination thereof.

In an eightieth set of embodiments, in addition to the limitations of each of the foregoing embodiments of the fifty-third through the seventy-ninth sets of embodiments:
a) the compressor package comprises a first compressor package of a plurality of compressor packages of the natural gas system; and
b) the EMM is connected to the plurality of compressor packages in parallel whereby the emissions management module is configured to capture emissions from each of the plurality of compressor packages.

For the sake of brevity, only certain ranges are explicitly disclosed herein. However, in addition to recited ranges, any lower limit may be combined with any upper limit to recite a range not explicitly recited, as well as, ranges from any lower limit may be combined with any other lower limit to recite a range not explicitly recited, and in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited. All documents described herein are incorporated by reference herein, including any priority documents and/or testing procedures, to the extent they are not inconsistent with this text. As is apparent from the foregoing general description and the specific embodiments, while forms of the invention have been illustrated and described, various modifications can be made without departing from the spirit and scope of the invention.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A natural gas system, comprising:
a process suction conduit;
a compressor package connected downstream of the process suction conduit and configured to receive a flow of natural gas from the process suction conduit and to increase a pressure of the flow of natural gas whereby the flow of natural gas is discharged from the compressor package as a pressurized flow of natural gas;
a process discharge conduit connected downstream of the compressor package and configured to receive the flow of natural gas discharged from the compressor package; and
an emissions management module (EMM) coupled to the compressor package and configured to capture emissions from the compressor package, wherein the EMM comprises a vapor recovery unit (VRU) configured to periodically circulate the captured emissions from the VRU to an emissions discharge conduit.

2. The natural gas system of claim 1, wherein:
the EMM further comprises an emissions inlet conduit and a VRU control system;
the VRU comprises a circulator;
the periodic circulation of the captured emissions from the VRU to the emissions discharge conduit is enabled by the VRU control system:
activating the circulator to withdraw the captured emissions from the emissions inlet conduit when a pressure in the inlet conduit reaches an upper threshold value;
circulating the withdrawn captured emissions from the emissions inlet conduit to the emissions discharge conduit, thereby reducing the pressure in the emissions inlet conduit; and
deactivating the circulator to terminate withdrawal of the captured emissions from the emissions inlet conduit when the pressure in the emissions inlet conduit reaches a lower threshold value.

3. The natural gas system of claim 2, wherein the VRU control system deactivates the circulator if the pressure in the emissions inlet conduit does not reach the lower threshold within a preselected time period.

4. The natural gas system of claim 2, wherein:
the emissions inlet conduit fluidly connects the VRU to an emissions source having an initial pressure greater than the upper threshold value; and
the captured emissions flow from the emissions source to the emissions discharge conduit based on differential pressure until the pressure in the emissions inlet conduit reaches the upper threshold value.

5. The natural gas system of claim 4, wherein the ratio of the upper threshold value of pressure in the emissions inlet conduit to the pressure in the emissions discharge conduit is in a range of from 1 to 2.

6. The natural gas system of claim 4, wherein the captured emissions comprise emissions from a blowdown system of the compressor package, a blowdown system of the natural gas system other than the blowdown system of the compressor package, or a combination thereof.

7. The natural gas system of claim 2, wherein:
the emissions inlet conduit fluidly connects the VRU to an emissions source having an initial pressure less than the upper threshold value; and
the captured emissions accumulate in the emissions inlet conduit until the pressure in the emissions inlet conduit reaches the upper threshold value.

8. The natural gas system of claim 7, wherein the upper threshold value is in a range of from twice the lower threshold value to less than the pressure in the emissions discharge conduit.

9. The natural gas system of claim 7, wherein the inlet conduit further comprises a suction tank.

10. The natural gas system of claim 7, wherein the captured emissions comprise emissions from the compressor package when in operation, a hydrocarbon processing component in the natural gas system in operation other than the compressor package, or a combination thereof.

11. The natural gas system of claim 7, wherein the captured emissions comprise emissions from a seal system of the compressor package, a vent system of the compressor package, a vent system of the natural gas system other than the vent system of the compressor package, or a combination thereof.

12. The natural gas system of claim 1, wherein the emissions discharge conduit delivers the captured emissions to the process suction conduit, a fuel gas system of the natural gas system, a hydrocarbon processing component that is separate from the compressor package, or a combination thereof.

13. The natural gas system of claim 2, wherein the circulator comprises a compressor and a motor configured to drive the compressor.

14. The natural gas system of claim 2, wherein the circulator comprises a gas ejector powered by a motive fluid flow.

15. The natural gas system of claim 14, wherein the motive fluid flow comprises a flow of natural gas from the process discharge conduit.

16. The natural gas system of claim 1, wherein:
the EMM comprises a support structure on which the VRU is supported; and
the support structure comprises a road transportable skid.

17. The natural gas system of claim 1, further comprising:
a plurality of the compressor packages arranged in parallel with respect to each other, and a plurality of the EMMs, wherein each of the EMMs is associated with one of the plurality of the compressor packages.

18. The natural gas system of claim 1, wherein the VRU comprises:
a high-pressure circuit comprising a high-pressure gas circulator configured to receive a first stream of emissions from the compressor package; and
a low-pressure circuit comprising a low-pressure gas circulator configured to receive a second stream of emissions from the compressor package.

19. The natural gas system of claim 18, wherein:
the high-pressure gas circulator comprises a high-pressure compressor or a high-pressure gas ejector; and
the low-pressure gas circulator comprises a low-pressure compressor or a low-pressure gas ejector.

20. The natural gas system of claim 18, wherein one of the high-pressure gas circulator and the low-pressure gas circulator discharges into a fuel gas system of the compressor package, a fuel gas system of the natural gas system other than the fuel gas system of the compressor package, or a combination thereof.

21. The natural gas system of claim 1, wherein:
the compressor package comprises a first compressor package of a plurality of compressor packages of the natural gas system; and
the EMM is connected to the plurality of compressor packages in parallel whereby the emissions management module is configured to capture emissions from each of the plurality of compressor packages.

22. An emissions management module (EMM) for a natural gas system, comprising:
a support structure;
a high-pressure emissions inlet conduit supported on the support structure and configured to receive a high-pressure stream of emissions from the natural gas system;
a low-pressure emissions inlet conduit supported on the support structure and configured to receive a low-pressure stream of emissions from the natural gas system;
a vapor recovery unit (VRU) supported on the support structure and connected to both the high-pressure emissions inlet conduit and the low-pressure emissions inlet conduit; and
a high-pressure emissions discharge conduit and a low-pressure emissions discharge conduit connected to the VRU, wherein the VRU is configured to periodically circulate the high-pressure stream of emissions and/or the low-pressure stream of emissions from the VRU to a component of the natural gas system.

23. The EMM of claim 22, further comprising a VRU control system, wherein:
the VRU comprises a circulator;
the periodic circulation of the captured emissions from the VRU to the low-pressure emissions discharge conduit or the high-pressure emissions discharge conduit is enabled by the VRU control system:
activating the circulator to withdraw the captured emissions from the low-pressure emissions inlet conduit or the high-pressure emissions inlet conduit, respectively, when a pressure in the low-pressure emissions inlet conduit or the high-pressure emissions inlet conduit, respectively, reaches an upper threshold value;
circulating the withdrawn captured emissions from the low-pressure emissions inlet conduit or the high-pressure emissions inlet conduit, respectively, to the low-pressure emissions discharge conduit or the high-pressure emissions discharge conduit, respectively, thereby reducing the pressure in the low-pressure emissions inlet conduit or the high-pressure emissions inlet conduit, respectively; and
deactivating the circulator to terminate withdrawal of the captured emissions from the low-pressure emissions inlet conduit or the high-pressure emissions inlet conduit, respectively, when the pressure in the low-pressure emissions inlet conduit or the high-pressure emissions inlet conduit, respectively, reaches a lower threshold value.

24. The EMM of claim 23, wherein the VRU control system deactivates the circulator if the pressure in the low-pressure emissions inlet conduit or the high-pressure emissions inlet conduit, respectively, does not reach the lower threshold within a preselected time period.

25. The EMM of claim 23, wherein:
the emissions inlet conduit fluidly connects the VRU to an emissions source having an initial pressure greater than the upper threshold value; and
the captured emissions flow from the emissions source to the emissions discharge conduit based on differential pressure until the pressure in the emissions inlet conduit reaches the upper threshold value.

26. The EMM of claim 25, wherein the ratio of the upper threshold value of pressure in the emissions inlet conduit to the pressure in the emissions discharge conduit is in a range of from 1 to 2.

27. The EMM of claim 25, wherein the captured emissions comprise emissions from a blowdown system of a compressor package, a blowdown system of the natural gas system other than the blowdown system of the compressor package, or a combination thereof.

28. The EMM of claim 23, wherein:
the emissions inlet conduit fluidly connects the VRU to an emissions source having an initial pressure less than the upper threshold value; and
the captured emissions accumulate in the emissions inlet conduit until the pressure in the emissions inlet conduit reaches the upper threshold value.

29. The EMM of claim 28, wherein the upper threshold value is in a range of from twice the lower threshold value to less than the pressure in the emissions discharge conduit.

30. The EMM of claim 28, wherein the low-pressure emissions inlet conduit further comprises a suction tank.

31. The EMM of claim 28, wherein the captured emissions comprise emissions from a compressor package when in operation, a hydrocarbon processing component in the natural gas system in operation other than the compressor package, or a combination thereof.

32. The EMM of claim 28, wherein the captured emissions comprise emissions from a seal system of a compressor package, a vent system of the compressor package, a vent system of the natural gas system other than the vent system of the compressor package, or a combination thereof.

33. The EMM of claim 22, wherein the low-pressure emissions discharge conduit and/or the high-pressure emissions discharge conduit delivers the captured emissions to a process suction conduit of a compressor package, a fuel gas system of the natural gas system, a hydrocarbon processing component that is separate from the compressor package, or a combination thereof.

34. The EMM of claim 23, wherein the circulator comprises a compressor and a motor configured to drive the compressor.

35. The EMM of claim 23, wherein the circulator comprises a gas ejector powered by a motive fluid flow.

36. The EMM of claim 35, wherein the motive fluid flow comprises a flow of natural gas from a process discharge conduit of a compressor package.

37. A method for capturing emissions from a compressor package of a natural gas system, the method comprising:
(a) transporting a flow of natural gas from a process suction conduit of the natural gas system to a compressor package of the natural gas system;
(b) increasing a pressure of the flow of natural gas received from the process suction conduit by the compressor package;
(c) discharging the flow of natural gas from the compressor package to a process discharge conduit of the natural gas system;
(d) capturing emissions from the compressor package in an emissions inlet conduit of an emissions management module (EMM) of a natural gas system; and
(e) periodically circulating the captured emissions by a vapor recovery unit (VRU) of the EMM to the process suction conduit, a fuel gas system of the natural gas system, a hydrocarbon processing component that is separate from the com-pressor package, or a combination thereof.

38. The method of claim 37, wherein:
the EMM further comprises an emissions inlet conduit and a VRU control system;
the VRU comprises a circulator;
the periodic circulation of the captured emissions from the VRU to the emissions discharge conduit is enabled by the VRU control system:
activating the circulator to withdraw the captured emissions from the emissions inlet conduit when a pressure in the inlet conduit reaches an upper threshold value;
circulating the withdrawn captured emissions from the emissions inlet conduit to the emissions discharge conduit, thereby reducing the pressure in the emissions inlet conduit; and
deactivating the circulator to terminate withdrawal of the captured emissions from the emissions inlet conduit when the pressure in the emissions inlet conduit reaches a lower threshold value.

39. The method of claim 38, wherein the VRU control system deactivates the circulator if the pressure in the emissions inlet conduit does not reach the lower threshold within a preselected time period.

40. The method of claim 38, wherein:
the emissions inlet conduit fluidly connects the VRU to an emissions source having an initial pressure greater than the upper threshold value; and
the captured emissions flow from the emissions source to the emissions discharge conduit based on differential pressure until the pressure in the emissions inlet conduit reaches the upper threshold value.

41. The method of claim 40, wherein the captured emissions comprise emissions related to shutdown of the compressor package, shutdown of a hydrocarbon processing component in the natural gas system other than the compressor package, or a combination thereof.

42. The method of claim 40, wherein the captured emissions comprise emissions from a blowdown system of the compressor package, a blowdown system of the natural gas system other than the blowdown system of the compressor package, or a combination thereof.

43. The method of claim 38, wherein:
the emissions inlet conduit fluidly connects the VRU to an emissions source having an initial pressure less than the upper threshold value; and
the captured emissions accumulate in the emissions inlet conduit until the pressure in the emissions inlet conduit reaches the upper threshold value.

44. The method of claim 43, wherein the captured emissions comprise emissions from the compressor package when in operation, a hydrocarbon processing component in the natural gas system in operation other than the compressor package, or a combination thereof.

45. The method of claim 43, wherein the captured emissions comprise emissions from a seal system of the compressor package, a vent system of the compressor package, a vent system of the natural gas system other than the vent system of the compressor package, or a combination thereof.

46. The method of claim 37, wherein the emissions discharge conduit delivers the captured emissions to the process suction conduit, a fuel gas system of the natural gas system, a hydrocarbon processing component that is separate from the compressor package, or a combination thereof.
